(19) United States
(12) Patent Application Publication
(10) Pub. No.: US 2014/0336909 A1
(43) Pub. Date: Nov. 13, 2014

(54) SYSTEM AND METHOD OF USING ROTATIONAL SPEED PREDICTIONS FOR STARTER CONTROL

(71) Applicant: DENSO CORPORATION, Kariya-city (JP)

(72) Inventors: Emmanuel DOIT, Broughton-Astley (GB); Ian AITCHISON, Rugby (GB); Graham WEST, Leamington Spa (GB)

(73) Assignee: DENSO CORPORATION, Kariya-city (JP)

(21) Appl. No.: 13/891,319

(22) Filed: May 10, 2013

(51) Int. Cl. F02N 15/02

(52) U.S. Cl. CPC F02N 15/02
USPC 701/113

(57) ABSTRACT

A system and method of coupling a pinion of a starter to a crankshaft of an internal combustion engine, including: predicting a future trajectory of the drop of the rotational speed of the crankshaft based on information associated with the drop of the rotational speed of the crankshaft and determining a timing of the driving of the starter based on the future trajectory of the drop of the rotational speed of the internal combustion engine.

### TECHNICAL FIELD

The present disclosure relates to a system and method of using rotational speed predictions of a crankshaft of an internal combustion engine to control a starter so as to shift a pinion of the starter to a ring gear coupled to the crankshaft so as to engage the pinion with the ring gear during the dropping of the rotational speed of the crankshaft based on automatic stop control of the internal combustion engine so that the engine can be restarted.

### BACKGROUND

Japanese Patent Application Publication No. 2005-330813 discloses an engine stop-and-start system, such as an idle reduction control system, as one type of these systems.

Specifically, the engine stop-and-start system is designed to energize a motor of a starter to rotate a pinion of the starter at the timing when an engine restart request occurs during a rotational speed of a crankshaft of an internal combustion engine, referred to simply as an engine, dropping based on automatic stop control of the engine.

U.S. patent application Ser. No. 12/962,840 (U.S. Patent Publication No. 2011/0137544; hereinafter “Kawazu”), which is incorporated by reference in its entirety, discloses an engine stop-and-start system which predicts the timing when the rotational speed of the crankshaft (ring gear) will be within an acceptable range of the rotational speed of the pinion in consideration of a time required for the pinion to reach a position engageable with the ring gear. In predicting the future trajectory of the rotational speed of the crankshaft, however, Kawazu assumes that the loss of torque (and loss of kinetic energy) will be equal from one stroke of the engine to the next. Because this assumption is not always correct, one of ordinary skill in the art would appreciate the need for an improved system and method to predict the future trajectory of the rotational speed of the crankshaft in order to engage the pinion of the starter motor.

Additionally, there is a need for an improved system and method for predicting a time when the crankshaft of the internal combustion engine will experience negative or reverse rotation.

### SUMMARY

In certain exemplary embodiments of this invention, there is provided a system for driving a starter including a pinion so that the starter rotates a ring gear coupled to a crankshaft of an internal combustion engine to crank the internal combustion engine during a drop of a rotational speed of the crankshaft by automatic-stop control of the internal combustion engine, the system comprising: a processing system, comprising a computer processor, configured to: predict multiple future trajectories of the drop of the rotational speed of the crankshaft based on information associated with the drop of the rotational speed of the crankshaft; and determine a timing of the driving of the starter based on these multiple future trajectories.

In other exemplary embodiments of this invention, the multiple future trajectories may represent any two or more of either a minimum bound of a range of values of predicted rotational speeds of the crankshaft, a maximum bound of the range of values of predicted rotational speeds of the crankshaft, or a predicted rotational speed of the crankshaft having values within the range of values of the predicted rotational speeds of the crankshaft. The processing system may be further configured to compare any 2 or more of the multiple future trajectories and determine whether an error in speed prediction exists. The processing system may be further configured to select the future trajectory representing the minimum bound of a range of values of predicted rotational speeds of the crankshaft if an error in speed prediction exists. The processing system may be further configured to determine the timing of the driving of the starter based on at least a portion the future trajectory being within a predetermined range of rotational speed values.

In other exemplary embodiments of this invention, the timing of the driving of the starter may be determined based on at least a portion the future trajectories being within a predetermined range of rotational speed values.

In other exemplary embodiments of this invention, the multiple future trajectories may be: a first future trajectory of the drop of the rotational speed of the crankshaft based on information associated with the drop of the rotational speed of the crankshaft; a second future trajectory of the drop of the rotational speed of the crankshaft based on information associated with the drop of the rotational speed of the crankshaft; and a third future trajectory of the drop of the rotational speed of the crankshaft based on information associated with the drop of the rotational speed of the crankshaft; and the processing system may be configured to determine a timing of the driving of the starter based on the first future trajectory, the second future trajectory, and the third future trajectory.

In other exemplary embodiments of this invention, the first future trajectory may represent predicted rotational speeds of the crankshaft having values which are greater than those of the second trajectory but less than those of the third future trajectory. The second future trajectory and the third future trajectory may respectively represent minimum and maximum bounds of a range of values of predicted rotational speeds of the crankshaft, the first future trajectory representing predicted rotational speeds of the crankshaft having values within the range. The range may be determined based on an analysis of energy loss of engine rundown data from test combustion engines or alternatively based on an analysis of energy loss of engine rundown data from the internal combustion engine.

In other exemplary embodiments of this invention, the first future trajectory may be predicted based on a ratio of an energy loss on a next stroke of the engine to an energy loss on a previous stroke of the engine being equal to 1, the second future trajectory may be predicted based on a ratio of an energy loss on a next stroke of the engine to an energy loss on a previous stroke of the engine not being equal to 1, and the third future trajectory may be predicted based on a ratio of an energy loss on a next stroke of the engine to an energy loss on a previous stroke of the engine not being equal to 1. More specifically, the second future trajectory may be predicted based on the ratio of the energy loss on the next stroke of the engine to the energy loss on the previous stroke of the engine being greater than 1, and the third future trajectory may be predicted based on the ratio of an energy loss on the next stroke of the engine to the energy loss on a previous stroke of the engine being less than 1.

In other exemplary embodiments of this invention, the timing of the driving of the starter may be determined based on at least a portion of each of the first, second and third future trajectories being within a predetermined range of rotational speed values. More specifically, the timing of the driving of the starter may be determined based on at least a portion of each of the first, second and third future trajectories being within the predetermined range of rotational speed values during a pinion travel time range.

In other exemplary embodiments of this invention, the determination of the timing of the driving of the starter may include determination of a first timing to drive a pinion actuator to shift the pinion to the ring gear and a second timing to drive a motor to rotate the pinion.

In other exemplary embodiments of this invention, the processing system may be further configured to calculate a time to preset the pinion to the ring gear based on the first, second and third trajectories.

In other exemplary embodiments of this invention, the processing system may be further configured to select one of the first, second and third trajectories and calculate a time to preset the pinion to the ring gear based on the selected trajectory.

In other exemplary embodiments of this invention, the processing system may be further configured to select one of the first, second and third trajectories and calculate a time when the engine will enter a reverse rotation based on the selected trajectory.

In other exemplary embodiments of this invention, the timing of the driving of the starter may be determined based on at least a portion the future trajectories being within a predetermined range of rotational speed values. More specifically, the timing of the driving of the starter may be determined based on at least a portion of the future trajectories being within the predetermined range of rotational speed values during a pinion travel time range. The timing of the driving of the starter may be determined based on at least a portion of the future trajectories being within the predetermined range of rotational speed values at two or more points during the pinion travel time range. The timing of the driving of the starter may be determined based on at least a portion of the future trajectories being within the predetermined range of rotational speed values during the entire pinion travel time range.

In certain exemplary embodiments of this invention, there is provided a system for driving a starter including a pinion so that the starter rotates a ring gear coupled to a crankshaft of an internal combustion engine to crank the internal combustion engine during a drop of a rotational speed of the crankshaft by automatic-stop control of the internal combustion engine, the system comprising: a processing system, comprising a computer processor, configured to: predict a future trajectory of the drop of the rotational speed of the crankshaft based on information associated with the drop of the rotational speed of the crankshaft, wherein the future trajectory is predicted based on a predicted energy loss on a next stroke of the engine which is not equal to a previous energy loss on a previous stroke of the engine; and determine a timing of the driving of the starter based on the future trajectory.

In other exemplary embodiments of this invention, the timing of the driving of the starter may be determined based on at least a portion the future trajectory being within a predetermined range of rotational speed values. More specifically, the timing of the driving of the starter may be determined based on at least a portion of the future trajectory being within the predetermined range of rotational speed values during a pinion travel time range. The timing of the driving of the starter may be determined based on at least a portion of the future trajectory being within the predetermined range of rotational speed values at two or more points during the pinion travel time range. The timing of the driving of the starter may be determined based on at least a portion of the future trajectory being within the predetermined range of rotational speed values during the entire pinion travel time range.

In certain exemplary embodiments of this invention, there is provided a system for driving a starter including a pinion so that the starter rotates a ring gear coupled to a crankshaft of an internal combustion engine to crank the internal combustion engine during a drop of a rotational speed of the crankshaft by automatic-stop control of the internal combustion engine, the system comprising: a processing system, comprising a computer processor, configured to: predict a future trajectory of the drop of the rotational speed of the crankshaft based on information associated with the drop of the rotational speed of the crankshaft; and determine a timing of the driving of the starter based on at least a portion the future trajectory being within a predetermined range of rotational speed values at two or more points during a pinion travel time range. The timing of the driving of the starter may be determined based on at least a portion of the future trajectory being within the predetermined range of rotational speed values during the entire pinion travel time range.

### BRIEF DESCRIPTION OF THE DRAWINGS

Other objects and aspects of the invention will become apparent from the following description of embodiments with reference to the accompanying drawings, in which:

FIG. 1 illustrates a schematic representation of the overall hardware structure of an engine control system, according to exemplary embodiments of the present invention;

FIGS. 2(a)-(c) are timing charts illustrating three control modes in which an engine control system engages a pinion with a ring gear, according to exemplary embodiments of the present invention;

FIG. 3(a) is a timing chart illustrating a control mode in which an engine control system engages a pinion with a ring gear, according to exemplary embodiments of the present invention, and explaining which control mode is used depending on the timing of driver start request (shown for control pattern 1);

FIG. 3(b) is a timing chart illustrating four control patterns in which an engine control system engages a pinion with a ring gear and which determine the sequence of control modes used during engine stopping, according to exemplary embodiments of the present invention;

FIG. 3(c) is a graph illustrating the engine speed of an engine relative to the amount of time which has elapsed since an automatic stop of the engine according to exemplary embodiments of the present invention;

FIG. 3(d) is a graph illustrating examples of engine speeds of four cylinder engines relative to the number of crank angle degrees which have accumulated since an automatic stop of each engine according to exemplary embodiments of the present invention;

FIG. 3(e) is a graph illustrating example calculations of a ratio α of the loss of kinetic energy during a stroke of an engine to the loss of kinetic energy during a previous stroke of the engine according to exemplary embodiments of the present invention;

FIG. 3(f) is a graph illustrating the engine speed of an engine relative to the number of crank angle degrees which have accumulated since an automatic stop of the engine according to exemplary embodiments of the present invention;

FIG. 3(g) illustrates four examples of graphs illustrating the engine speed of an engine relative to the number of crank angle degrees which have accumulated since an automatic stop of the engine according to exemplary embodiments of the present invention;

FIG. 3(h) is a graph illustrating the a predicted future trajectory described above with reference to FIG. 3(g) in detail according to exemplary embodiments of the present invention;

FIG. 4 is a timing chart illustrating the engine speed of an engine after an automatic stop and a first, second, and third predicted future trajectories of the engine speed (i.e., normal, minimum and maximum predicted future trajectories of the engine speed), according to exemplary embodiments of the present invention;

FIG. 5(a) is a table illustrating examples of methods to calculate loss of torque of an internal combustion engine, the first, second, and third predicted future trajectories of the engine speed, and predicted values of arrival time of the crankshaft according to the exemplary embodiments of the present invention;

FIG. 5(b) is a table illustrating examples of methods to calculate the first, second, and third predicted future trajectories of the engine speed, and predicted values of arrival time of the crankshaft according to the exemplary embodiments of the present invention;

FIG. 6(a) is a flowchart illustrating a trajectory prediction routine to determine the first, second, and/or third predicted future trajectories, according to exemplary embodiments of the present invention;

FIG. 6(b) is a graph illustrating three predicted future trajectories which may be used to determine whether the predicted future trajectory of the engine speed is within the allowable relative speed range to mesh a pinion with a ring gear during a pinion travel time range according to exemplary embodiments of the present invention;

FIG. 6(c) is a graph illustrating three predicted future trajectories which may be used to determine whether the predicted future trajectory of the engine speed is within the allowable relative speed range to mesh a pinion with a ring gear during a pinion travel time range according to exemplary embodiments of the present invention;

FIG. 7 is a flowchart illustrating a routine for selecting a predicted future trajectory for calculating a time to preset the pinion to the ring gear and a time when the engine will enter a reverse rotation, according to exemplary embodiments of the present invention;

FIG. 8 is a flowchart illustrating a routine for calculating the time to preset the pinion to the ring gear, according to exemplary embodiments of the present invention; and

FIG. 9 is a flowchart illustrating a routine for calculating the time when the engine will enter a reverse rotation, according to exemplary embodiments of the present invention.

### DETAILED DESCRIPTION OF EXEMPLARY EMBODIMENTS

A detailed description of exemplary embodiments is provided with reference to the accompanying drawings. In the embodiments, like parts between the embodiments, to which like reference characters are assigned, are omitted or simplified to avoid redundant detailed descriptions.

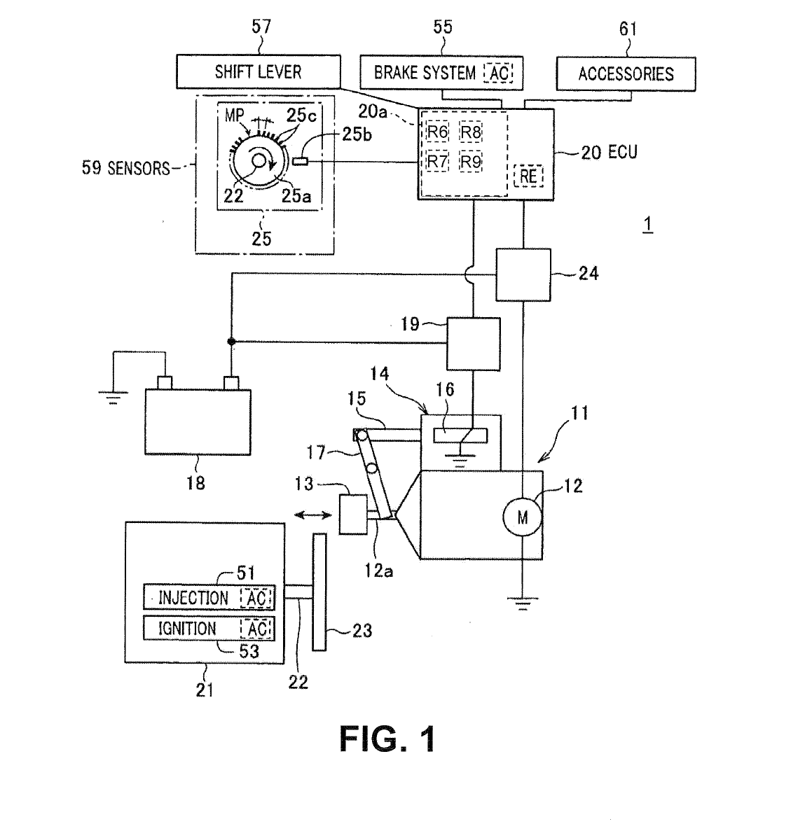

FIG. 1 illustrates a schematic representation of the overall hardware structure of an engine control system, according to exemplary embodiments of the present invention.

Referring to FIG. 1, the engine 21 includes a crankshaft 22, as an output shaft thereof, with one end to which a ring gear 23 is directly or indirectly coupled. The crankshaft 22 is coupled to the piston via a connection rod within each cylinder such that travel of the piston in each cylinder up and down allows the crankshaft 22 to be turned.

Specifically, the engine 21 works to compress air-fuel mixture or air by the piston within each cylinder and burn the compressed air-fuel mixture or the mixture of the compressed air and fuel within each cylinder. This changes the fuel energy to mechanical energy, such as rotative energy, to reciprocate the piston between a top dead center (TDC) to a bottom dead center (BDC) of each cylinder within each cylinder, thus rotating the crankshaft 22.

The engine 21 is installed with, for example, a fuel injection system 51 and an ignition system 53.

The fuel injection system 51 includes actuators, such as fuel injectors, AC and causes the actuators AC to spray fuel either directly into each cylinder of the engine 21 or into an intake manifold (or intake port) just ahead of each cylinder thereof to thereby burn the air-fuel mixture in each cylinder of the engine 21.

The ignition system 53 includes actuators AC, such as igniters, and causes the actuators AC to provide an electric current or spark to ignite an air-fuel mixture in each cylinder of the engine 21, thus burning the air-fuel mixture. When the engine 21 is designed as a diesel engine, the ignition system 53 can be eliminated.

In addition, a brake system 55 is installed in the motor vehicle for slowing down or stopping the motor vehicle. The brake system 55 includes, for example, disc or drum brakes as actuators AC at each wheel of the motor vehicle. The brake system 55 is operative to send a deceleration signal to each of the brakes indicative of a braking force to be applied from each brake to a corresponding one of the wheels in response to a brake pedal of the motor vehicle being depressed by the driver. This causes each brake to slow down or stop the rotation of a corresponding one of the wheels of the motor vehicle based on the deceleration signal.

Reference numeral 57 represents a hand-operable shift lever (select lever). When the motor vehicle is a manual transmission vehicle, the driver can change a position of the shift lever 57 to shift (change) a transmission gear ratio of the powertrain to thereby control the number of revolutions of the driving wheels and the torque generated by the engine 21 to the driving wheels. When the motor vehicle is an automatic transmission vehicle, the driver can change a position of the shift lever 57 to select one of the drive ranges corresponding to a transmission gear ratio of the powertrain, such as reverse range, neutral range, drive range, and the like.

Referring to FIG. 1, the engine control system 1 includes a starter 11, a chargeable battery 18, a relay 19, and a switching element 24.

The starter 11 includes of a starter motor (motor) 12, a pinion 13, and a pinion actuator 14. The motor 12 includes an output shaft 12a and an armature coupled to the output shaft 12a and operative to rotate the output shaft 12a when the armature is energized. The pinion 13 is mounted on the outer surface of one end of the output shaft 12a to be shiftable in an axial direction of the output shaft 12a.

The motor 12 is arranged opposing the engine 21 such that the shift of the pinion 13 in the axial direction of the output shaft 12a, toward the engine 21 allows the pinion 13 to abut on the ring gear 23 of the engine 21.

The pinion actuator 14, referred to simply as an “actuator,” includes a plunger 15, a solenoid 16, and a shift lever 17. The plunger 15 is so arranged in parallel to the axial direction of the output shaft 12a of the motor 12 as to be shiftable in its length direction parallel to the axial direction of the output shaft 12a.

The solenoid 16 is, for example, arranged to surround the plunger 15. One end of the solenoid 16 is electrically connected to a positive terminal of the battery 18 via the relay 19, and the other end thereof is grounded. The shift lever 17 has one end and the other end in its length direction. The one end of the shift lever 17 is pivotally coupled to one end of the plunger 15, and the other end thereof is coupled to the output shaft 12a. The shift lever 17 is pivoted about a pivot located at its substantially middle in the length direction.

The solenoid 16 works to shift the plunger 15 in the length direction of the plunger 15 so as to pull the plunger 15 against the force of return spring (not shown) when energized. The pull-in shift of the plunger 15 pivots the shift lever 17 clockwise in FIG. 1 whereby the pinion 13 is shifted to the ring gear 23 of the engine 21 via the shift lever 17. This allows the pinion 13 to be meshed with the ring gear 23 for cranking the engine 21. When the solenoid 16 is de-energized, the return spring returns the plunger 15 and the shift lever 17 to their original positions illustrated in FIG. 1 so that the pinion 13 is pulled-out of mesh with the ring gear 23.

The relay 19 is designed as a mechanical relay or a semiconductor relay. The relay 19 has first and second terminals (contacts) electrically connected to the positive terminal of the battery 18 and the one end of the solenoid 16, respectively, and a control terminal electrically connected to an electronic control unit (ECU) 20.

For example, when an electric signal indicative of switch-on of the relay 19 is sent from the ECU 20, the relay 19 establishes electric conduction between the first and second terminals of the relay 19 to switch on the relay 19. This allows the battery 18 to supply a direct current (DC) battery voltage to the solenoid 16 via the relay 19 to thereby energize the solenoid 16.

When energized, the solenoid 16 pulls the plunger 15 against the force of the return spring. The pull of the plunger 15 into the solenoid 16 causes the pinion 13 to be shifted to the ring gear 23 via the shift lever 17. This allows the pinion 13 to be meshed with the ring gear 23 for cranking the engine 21. Otherwise, when no electric signals are sent from the ECU 20 to the relay 19, the relay 19 is off, resulting in the solenoid 16 being de-energized. When the solenoid 16 is de-energized, the return spring of the actuator 14 returns the plunger 15 to its original position illustrated in FIG. 1 so that the pinion 13 is out of mesh with the ring gear 23 in its initial state.

The switching element 24 has first and second terminals electrically connected to the positive terminal of the battery 18 and the armature of the motor 12, respectively, and a control terminal electrically connected to the ECU 20.

For example, when an electric signal, such as a pulse current with a pulse width (pulse duration) corresponding to the energization duration (on period) of the switching element 24, is sent from the ECU 20 to the switching element 24, the switching element 24 establishes, during on period of the pulse current, electric conduction between the first and second terminals to thereby turn on the switching element 24. This allows the battery 18 to supply the battery voltage to the armature of the motor 12 to energize it.

The switching element 24 also interrupts, during off period of the pulse current, the electric conduction between the first and second terminals to thereby establish electrical disconnection between the battery 18 and the armature of the motor 12. When no pulse current is sent from the ECU 20 to the switching element 24, the switching element 24 is off so that the motor 12 is inactivated. A duty cycle of the motor 12 is represented as a ratio of the on period (pulse width) of the pulse current to the repetition interval (sum of the on and off periods) thereof. That is, the ECU 20 is adapted to adjust the on period (pulse width) of the pulse current to adjust the duty cycle of the motor 12 to thereby control the rotational speed of the motor 12, that is, the rotational speed of the pinion 13.

In addition, the engine control system 1 includes sensors 59 for measuring the operating conditions of the engine 21 and the driving conditions of the motor vehicle. Each of the sensors 59 is operative to measure an instant value of a corresponding one parameter associated with the operating conditions of the engine 21 and/or the motor vehicle and to output, to the ECU 20, a signal indicative of the measured value of a corresponding one parameter.

Specifically, the sensors 59 include, for example, a crank angle sensor (crankshaft sensor) 25, an accelerator sensor (throttle position sensor), and a brake sensor. The sensors 59 are electrically connected to the ECU 20.

The crank angle sensor 25 is operative to output a crank pulse to the ECU 20 each time the crankshaft 22 is rotated by a preset angle. An example of the specific structure of the crank angle sensor 25 will be described later.

The cam angle sensor is operative to measure the rotational position of a camshaft (not shown) as an output shaft of the engine 21, and output, to the ECU 20, a signal indicative of the measured rotational position of the camshaft. The camshaft is driven by gears, a belt, or a chain from the crankshaft 22, and is designed to turn at half the speed (angular velocity) of the crankshaft 22. The camshaft is operative to cause various valves in the engine 21 to open and close.

The accelerator sensor is operative to measure an actual position or stroke of a driver-operable accelerator pedal of the motor vehicle linked to a throttle valve for controlling the amount of air entering the intake manifold and output a signal indicative of the measured actual stroke or position of the accelerator pedal to the ECU 20.

The brake sensor is operative to measure an actual position or stroke of the brake pedal of the vehicle operable by the driver and to output a signal indicative of the measured actual stroke or position of the brake pedal.

The crank angle sensor 25 may be a normal magnetic-pickup type angular sensor is used in this embodiment. Specifically, the crank angle sensor 25 includes a reluctor disk (pulses) 25a coupled to the crankshaft 22 to be integrally rotated therewith. The crank angle sensor 25 also includes an electromagnetic pickup (referred to simply as “pickup”) 25b arranged in proximity to the reluctor disk 25a.

The reluctor disk 25a has teeth 25c, spaced at preset crank-angle intervals around the outer circumferential surface thereof. For example, the preset crank-angle intervals of reluctor disk 25a may be 30 degree intervals (n/6 radian intervals). The reluctor disk 25a also has, for example, one tooth missing portion MP at which a preset number of teeth, such as one tooth or several teeth, are missed. The preset crank-angle intervals define a crank-angle measurement resolution of the crank angle sensor 25. For example, when the teeth 25c are spaced at 30-degree intervals, the crank-angle measurement resolution is set to 30 degrees.

The pickup 25b is designed to pick up a change in a previously formed magnetic field according to the rotation of the teeth 25c of the reluctor disk 25a to thereby generate a crank pulse, which is a transition of a base signal level to a preset signal level.

Specifically, the pickup 25b is operative to output a crank pulse every time one tooth 25c of the rotating reluctor disk 25a passes in front of the pickup 25b.

The train of crank pulses outputted from the pickup 25b, which is referred to as a “crank signal,” is sent to the ECU 20. The crank signal is used by the ECU 20 to calculate the angular velocity (or rotational speed or engine speed) of the engine 21 and the crankshaft 22.

The ECU 20 is designed as, for example, a normal microcomputer system comprising, for example, a central processing unit (CPU) which includes at least a computer processor, a storage medium 20a which may include a read only memory (ROM), such as a rewritable ROM, a random access memory (RAM), etc., an input and output (I/O) interface, etc. The normal microcomputer system includes at least a CPU and a main memory therefore.

The storage medium 20a stores various engine control programs therein such as those including executable instructions corresponding to the steps illustrated in Figures

The ECU 20 is operative to receive the signals outputted from the sensors 59, and control various actuators AC installed in the engine 21 to thereby adjust various controlled variables of the engine 21 based on the operating conditions of the engine 21 determined by at least some of the received signals from the sensors 59.

The ECU 20 is operative to determine, based on the crank signal outputted from the crank angle sensor 25, a rotational position (crank angle) of the crankshaft 22 relative to a reference position and the rotational speed NE of the engine 21, and determine various operating timings of the actuators AC based on the crank angle of the crankshaft 22 relative to the reference position. The reference position can be determined based on the location of the tooth missing portion MP and/or on the signal outputted form the camshaft sensor.

Specifically, the ECU 20 is programmed to adjust a quantity of intake air into each cylinder, compute a proper fuel injection timing and a proper injection quantity for the fuel injector AC for each cylinder and a proper ignition timing for the igniter AC for each cylinder, instruct the fuel injector AC for each cylinder to spray a corresponding computed proper quantity of fuel into each cylinder at a corresponding computed proper injection timing, and instruct the igniter AC for each cylinder to ignite the compressed air-fuel mixture or the mixture of the compressed air and fuel in each cylinder at a corresponding computed proper ignition timing.

In addition, the engine control programs stored in the storage medium 20a include an engine stop-and-start control routine (program). For example, the ECU 20 repeatedly runs the engine stop-and-start control routine while the ECU 20 runs a main engine control routine. The main engine control routine is continuously run by the ECU 20 during the ECU 20 being ON.

Specifically, in accordance with the engine stop-and-start control routine, the ECU 20 repetitively determines whether at least one of predetermined engine automatic stop conditions is met, in other words, whether an engine automatic stop request (idle reduction request) occurs based on the signals outputted from the sensors 59.

Upon determining that no predetermined engine automatic stop conditions are met, the ECU 20 exits the engine stop-and-start control routine.

Otherwise, upon determining that at least one of the predetermined engine automatic stop conditions is met, that is, an automatic stop request occurs, the ECU 20 carries out an engine stop-and-start task. Specifically, the ECU 20 performs an automatic stop of the engine 21 by controlling the fuel injection system 51 to stop the supply of fuel (cut fuel) into each cylinder, and/or controlling the ignition system 53 to stop the ignition of the air-fuel mixture in each cylinder, thus stopping the burning of the air-fuel mixture in each cylinder. For example, the ECU 20 may cut fuel to each cylinder to thereby automatically stop the engine 21.

The predetermined engine automatic stop conditions include, for example, the following conditions that: the engine speed is equal to or lower than a preset speed (idle-reduction execution speed) when either the stroke of the driver's accelerator pedal is zero (the driver completely releases the accelerator pedal) so that the throttle valve is positioned in its idle speed position or the driver depresses the brake pedal; and the motor vehicle is stopped during the brake pedal being depressed.

After the automatic stop of the engine 21, during the rotational speed of the engine 21 dropping, in other words, the crankshaft 22 coasting, the ECU 20 determines if an engine restart request occurs, based on the signals outputted from the sensors 59.

An engine restart request occurs, for example, when at least one operation for the start of the motor vehicle is operated by the driver and the accelerator pedal is depressed (the throttle valve is opened) to start the motor vehicle. The operations for the start of the motor vehicle include the driver completely releasing the brake pedal or changing the position of the shift lever 57 to the drive range (when the motor vehicle is an automatic vehicle).

In addition, an engine restart request may be input to the ECU 20 from at least one of accessories 61 installed in the motor vehicle. The accessories 61 include, for example, a battery-charge control system for controlling the state of charge (SOC) of the battery 18 or another battery and an air conditioner for controlling the temperature and/or humidity within the cab of the motor vehicle.

During execution of the engine stop-and-start control routine, the ECU 20 monitors the angular velocity (rotational speed) of the crankshaft 22 and the engine 21 (engine speed).

In order to smoothly engage the pinion 13 with the ring gear 23, the relative difference between the engine speed and the rotational speed of the pinion 13 must be within an allowable range. Engaging the pinion 13 with the ring gear 23 when the difference between the engine speed and the rotational speed of the pinion 13 is outside the allowable range increases engine noise and causes abrasive wear on the pinion 13 and/or the ring gear 23.

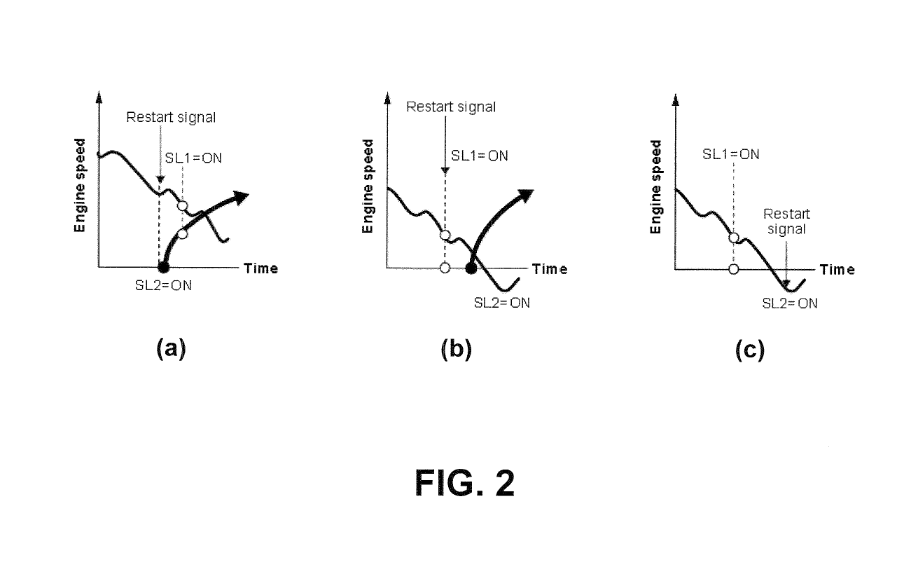

FIG. 2 illustrates three control modes in which engine control system 1 engages pinion 13 with ring gear 23, according to exemplary embodiments of the present invention.

FIG. 2(b) illustrates a rotate after engage (RaE) control mode. In RaE mode, during the rotational speed of the engine 21 dropping, a signal SL1 is output to enable solenoid 16 to shift the plunger 15, pivot the shift lever 17 clockwise, and shift the pinion 13 to be meshed with the ring gear 23 as described above. After the pinion 13 is engaged with the ring gear 23, a signal SL2 is output to rotate the pinion 13. In RaE mode, the signal SL1 to shift the pinion 13 to the ring gear 23 cannot be output until the rotational speed of the engine 21 falls within the allowable range to minimize abrasive wear and noise.

In order to execute the engine restart request more quickly, some vehicles may pre-rotate the pinion 13 in response to an engine restart request based on the signals outputted from the sensors 59. FIG. 2(a) illustrates a rotate before engage (RbE) control mode, in which a signal SL2 is output which enables pinion 13 to pre-rotate before a signal SL1 is output.

After the pre-rotation of the pinion 13, when it is determined that the difference between the rotational speed of the pinion 13 and that of the ring gear 23 is within an allowable range, the ECU 20 outputs the signal SL1 to shift the pre-rotating pinion 13 to the ring gear 23 so that the pre-rotating pinion 13 is smoothly engaged with the ring gear 23, thus cranking the engine 21.

In some instances, after the automatic stop of the engine 21, the rotational speed of the engine 21 may decrease to a level where the pinion 13 may be meshed with the ring gear 23 prior to an engine restart signal. In other words, the pinion 13 may be “pre-set” so that, when an engine restart request occurs based on the signals outputted from the sensors 59, the pinion 13 will already be engaged with the ring gear 23 and the starter 11 is able to quickly rotate both the pinion 13 and the engine 21.

FIG. 2(c) illustrates a preset pinion control mode in which the signal SL1 is output to mesh the pinion 13 with the ring gear 23 prior to the engine restart request. In pinion preset control mode, the pinion 13 is meshed with the ring gear 23 while the engine is at low speed or reverse rotation (for example, while the engine is oscillating).

After the engine restart task, the engine speed exceeds a preset threshold for determination of whether the start of the motor vehicle is completed. When the engine speed exceeds the preset threshold, the ECU 20 determines that the start of the motor vehicle is completed, thus de-energizing the motor 12 of the starter 11 via the switching element 24 and de-energizing the pinion actuator 14 via the relay 19. This allows the return spring returns the plunger 15 and the shift lever 17 to their original positions illustrated in FIG. 1 so that the pinion 13 is pulled-out of mesh with the ring gear 23 to be returned to its original position illustrated in FIG. 1.

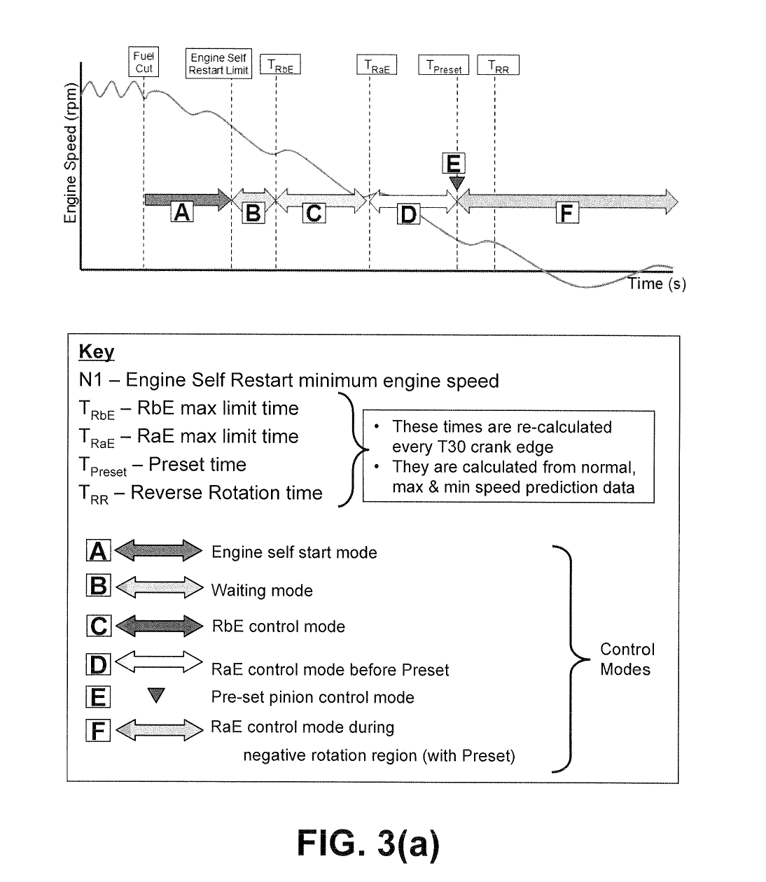

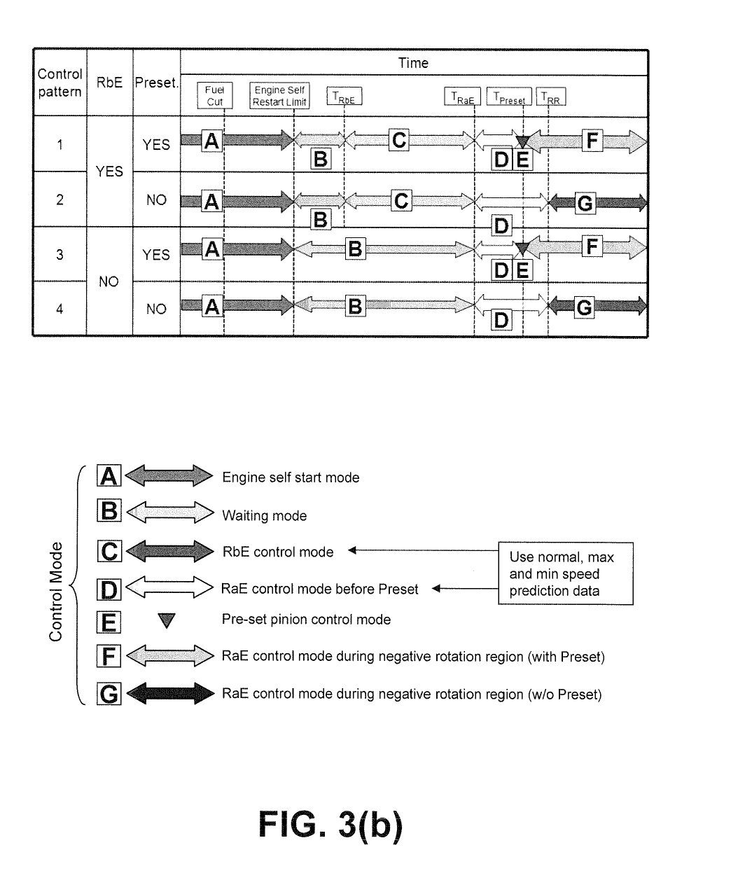

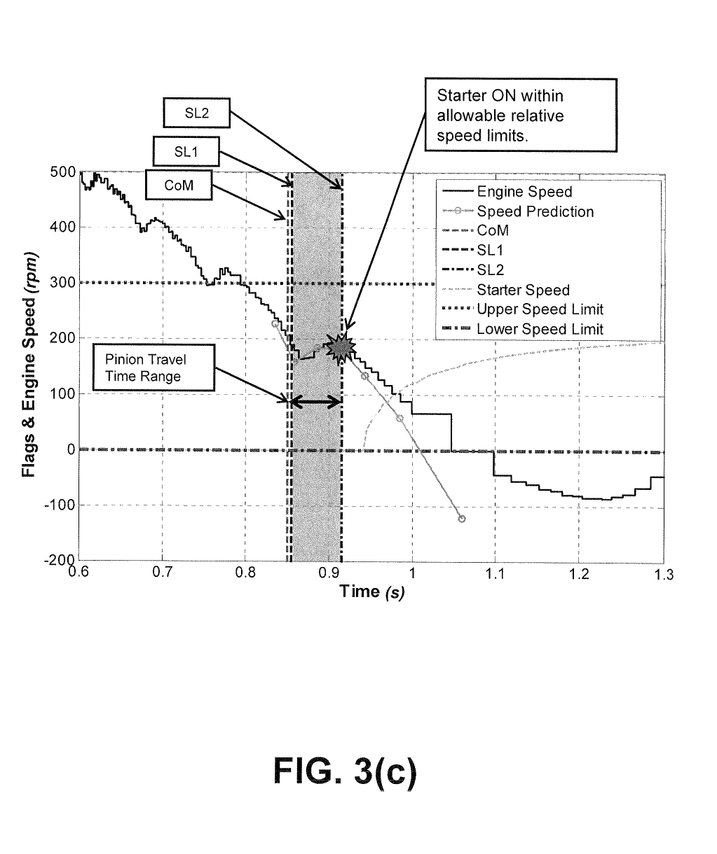

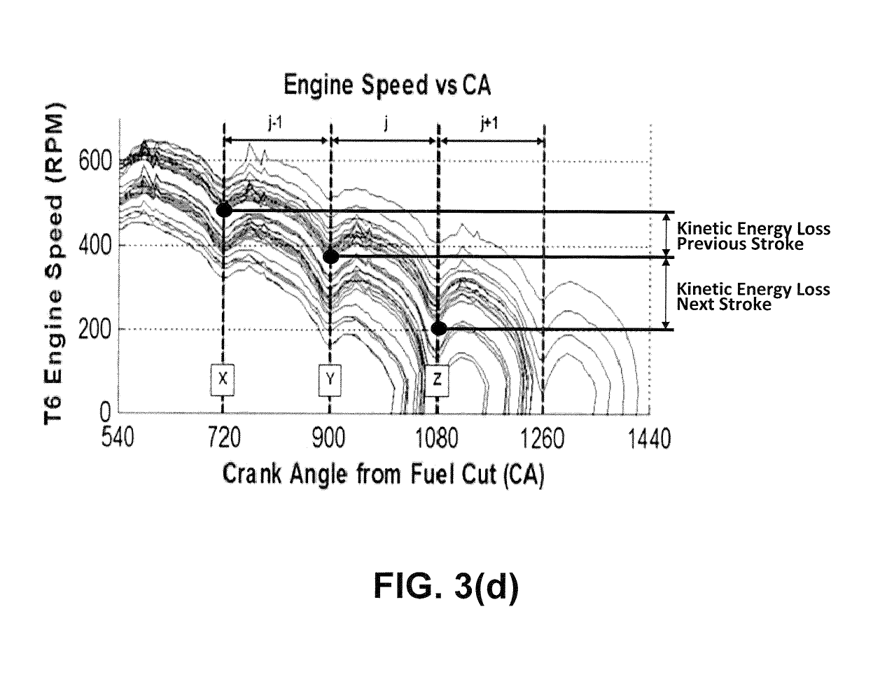

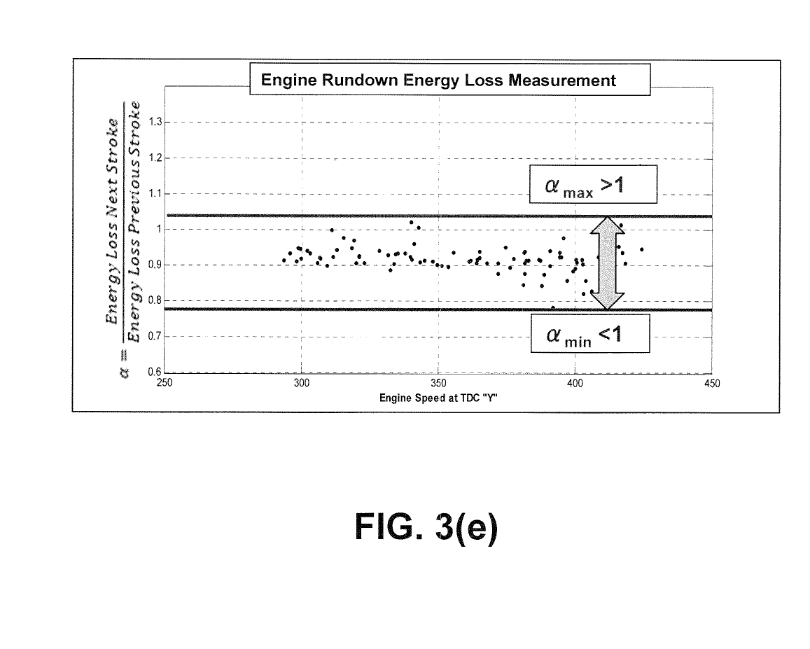

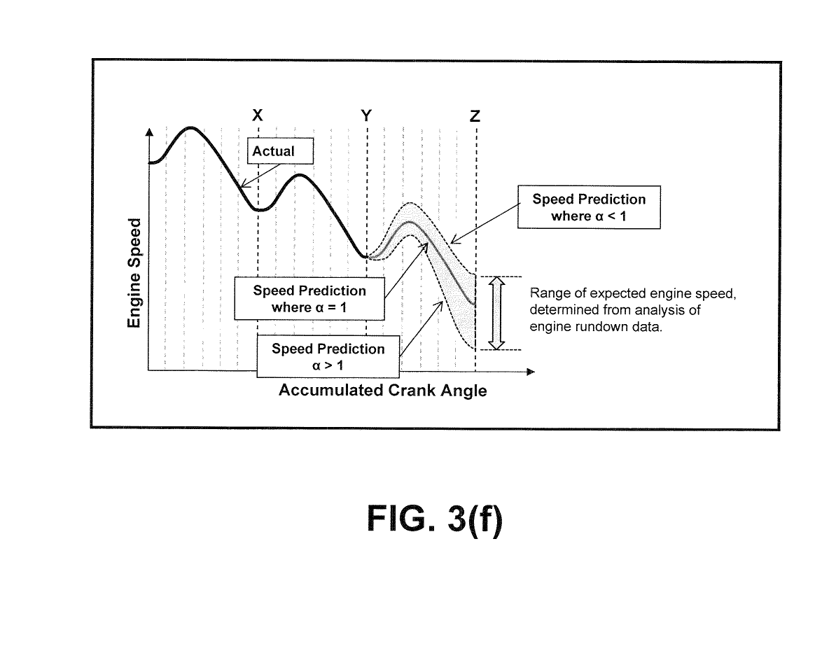

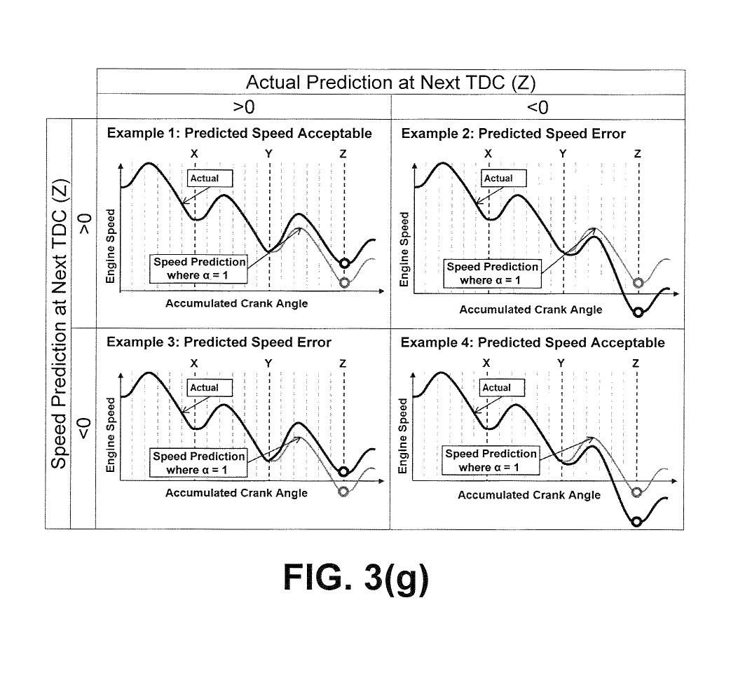

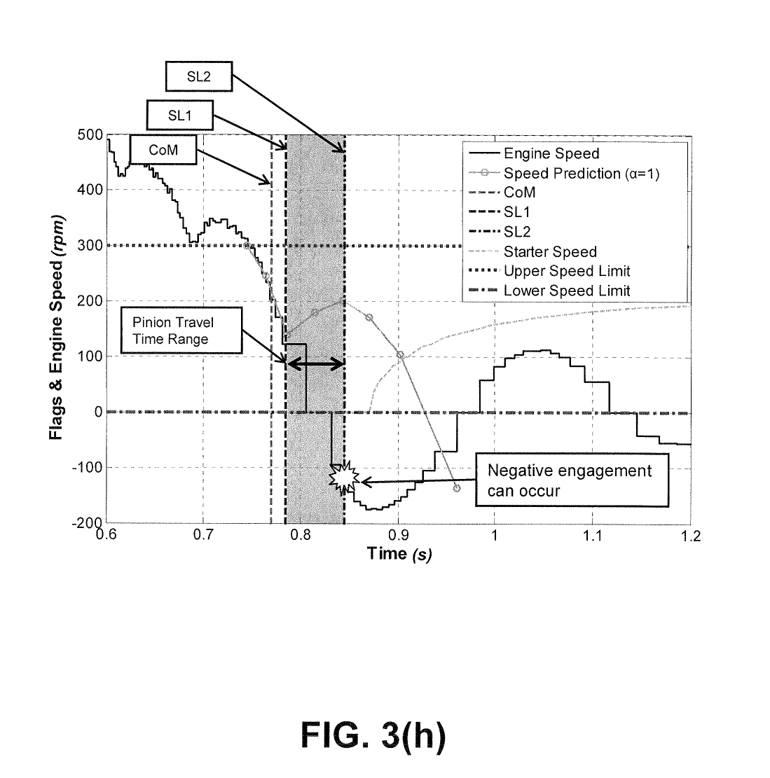

In addition to RaE control mode, some vehicles may be enabled with either or both the RbE control mode and the pinion preset control mode. FIG. 3(a) illustrates a timing chart of an engine stop-and-start task for a vehicle enabled with both the RbE control mode and the pinion preset control mode, according to exemplary embodiments of the present invention.

Referring to FIG. 3(a), fuel is cut by the ECU 20 in response to an engine automatic stop condition. As the rotational speed of the engine 21 (“engine speed” or rotational speed of the crankshaft 22 of the engine 21) drops, the ECU 20 monitors the sensors 59 to determine if an engine restart request has occurred. The time period A ends when the ECU 20 determines that the engine speed has reached the engine restart limit. If an engine restart request occurs during a time period A, the engine control system 1 enters an engine self start mode.

A time period B begins when the ECU 20 determines that the engine speed has reached the engine restart limit and ends at a time T_{RbE} when the ECU 20 determines that the engine speed has reached the maximum limit for the RbE control mode. If an engine restart request occurs during the time period B, the engine control system 1 enters a waiting mode until the time T_{RbE} and then performs an engine restart task using the RbE control mode.

A time period C begins at the time T_{RbE} and ends at a time T_{RaE} when the ECU 20 determines that the engine speed has reached the maximum limit for the RaE control mode. If an engine restart request occurs during the time period C, the engine control system 1 performs an engine restart task in the RbE control mode.

A time period D begins at the time T_{RaE} and ends at a time T_{Preset} when the ECU 20 determines that the engine speed has dropped to an acceptable level to preset the pinion 13. The calculation of the time T_{Preset} will be discussed in detail below. If an engine restart request occurs during the time period D, the engine control system 1 performs an engine restart task in the RaE control mode.

A time period E occurs at the time T_{Preset}. If the engine restart request does not occur until the preset time T_{Preset}, the engine control system 1 presets the pinion 13 as described above.

A time period F begins at the time T_{Preset}. If the engine restart request occurs during the time period F, the engine control system 1 performs an engine restart task in the RaE control mode with the pinion 13 having been preset.

FIG. 3(b) is a timing chart which illustrates control patterns which determine the sequence of control modes used by the engine control system 1, according to exemplary embodiments of the present invention.

FIG. 3(b) illustrates control patterns 1 through 4. As stated above, some vehicles may be enabled with either or both the RbE control mode and the pinion preset control mode in addition to the RaE control mode. Accordingly, a vehicle performs an engine stop-and-start routine according to one of four control patterns depending on whether the RbE control mode and/or the pinion preset control mode is/are enabled.

The control pattern 1 illustrates a vehicle which is enabled with both the RbE control mode and the pinion preset control mode. After an automatic stop condition, a vehicle in control pattern 1 responds to an engine restart request as described in detail above with reference to FIG. 3(a).

As shown in FIG. 3(b), the control pattern 2 illustrates a vehicle which is enabled with the RbE control mode without the pinion preset control mode. The control pattern 2 includes the time period A which ends when the ECU 20 determines that the engine speed has reached the engine restart limit. The time period B begins when the ECU 20 determines that the engine speed has reached the engine restart limit and ends at the time T_{RbE} when the ECU 20 determines that the engine speed has reached the maximum limit for the RbE control mode. The time period. C begins at the time T_{RbE} and ends at the time T_{RaE} when the ECU 20 determines that the engine speed has reached the maximum limit for the RaE control mode. The time period D begins at the time T_{RaE} and ends at a time T_{RR} when the ECU 20 determines that the engine speed has reached negative or reverse rotation. The calculation of the time T_{RR} will be described in detail below. A time period G begins at the time T_{RR}.

After an automatic stop condition, a vehicle in control pattern 2 responds to an engine restart request as follows: If an engine restart request occurs during a time period A, the engine control system 1 enters an engine self start mode. If an engine restart request occurs during the time period B, the engine control system 1 enters a waiting mode until the time T_{RbE} and then performs an engine restart task using the RbE control mode. If an engine restart request occurs during the time period C, the engine control system 1 performs an engine restart task in the RbE control mode. If an engine restart request occurs during the time period D, the engine control system 1 performs an engine restart task in the RaE control mode. If an engine restart request occurs during the time period G, the engine control system 1 performs an engine restart task in the RaE control mode during a period when the engine 23 may be in reverse rotation without the pinion 13 being preset.

The control pattern 3 illustrates a vehicle which is not enabled with the RbE control mode but is enabled with the pinion preset control mode. The control pattern 3 includes the time period A which ends when the ECU 20 determines that the engine speed has reached the engine restart limit. The time period B begins when the ECU 20 determines that the engine speed has reached the engine restart limit and ends at the time T_{RaE} when the ECU 20 determines that the engine speed has reached the maximum limit for the RaE control mode. The time period D begins at the time T_{RaE} and ends at the time T_{Preset} when the ECU 20 determines that the engine speed has dropped to an acceptable level to preset the pinion 13. The time period E occurs at the time T_{Preset}. The time period F begins at the time T_{Preset}.

After an automatic stop condition, a vehicle in control pattern 3 responds to an engine restart request as follows: If an engine restart request occurs during a time period A, the engine control system 1 enters an engine self start mode. If an engine restart request occurs during the time period B, the engine control system 1 enters a waiting mode until the time T_{RaE} and then performs an engine restart task using the RaE control mode. If an engine restart request occurs during the time period D, the engine control system 1 performs an engine restart task in the RaE control mode. If an engine restart request has not occurred at the time T_{Preset}, the engine control system 1 presets the pinion 13. In an engine restart request occurs during the time period F, the engine control system 1 performs an engine restart task in the RaE control mode during a period when the engine 23 may be in reverse rotation with the pinion 13 preset.

The control pattern 4 illustrates a vehicle which is not enabled with either the RbE control mode or the pinion preset control mode. The control pattern 4 includes the time period A which ends when the ECU 20 determines that the engine speed has reached the engine restart limit. The time period B begins when the ECU 20 determines that the engine speed has reached the engine restart limit and ends at the time T_{RaE} when the ECU 20 determines that the engine speed has reached the maximum limit for the RaE control mode. The time period D begins at the time T_{RaE} and ends at a time T_{RR}. A time period G begins at the time T_{RR}.

After an automatic stop condition, a vehicle in control pattern 4 responds to an engine restart request as follows: If an engine restart request occurs during a time period A, the engine control system 1 enters an engine self start mode. If an engine restart request occurs during the time period B, the engine control system 1 enters a waiting mode until the time T_{RaE} and then performs an engine restart task using the RaE control mode. If an engine restart request occurs during the time period D, the engine control system 1 performs an engine restart task in the RaE control mode. If an engine restart request occurs during the time period G, the engine control system 1 performs an engine restart task in the RaE control mode during a period when the engine 23 may be in reverse rotation without the pinion 13 being preset FIG. 3(e) is a graph illustrating the engine speed (angular velocity) of the engine 21 (“engine speed”) relative to the amount of time which has elapsed since an automatic stop of the engine 21 according to exemplary embodiments of the present invention.

The engine speed may be an absolute angular velocity of the engine 21 or the angular velocity of the engine 21 relative to the angular velocity of the pinion 13. The engine speed may be calculated, for example, by the ECU 20 based on input from the crank angle sensor 25. As described above, in order to smoothly engage pinion 13 with the ring gear 23, the relative difference between the engine speed and the angular velocity of the pinion 13 must be within an allowable relative speed range. In this example, the allowable relative speed range is shown between 300 rpm (“upper speed limit”) and 0 rpm (“lower speed limit”). After engine restart request (a change of mind “CoM”) occurs, there is a delay between the engine restart request and the pinion 13 engaging with the ring gear 23 which may vary based on, for example, software-based delay of ECU 20, hardware-based delay of ECU 20, actuator 14, solenoid 16, relay 19, etc., the temperature of engine 21, etc.). Variation in the delay causes a variation in the travel time of the pinion 13. Accordingly, the ECU 20 may store and/or calculate a range (“pinion travel time range”) to account for variations in pinion travel time.

After the automatic start request, the ECU 20 calculates a predicted future trajectory of the engine speed (“speed prediction”) and determines if the predicted future trajectory of the engine speed is within the allowable relative speed range to mesh the pinion 13 with the ring gear 20. For example, the ECU 20 may determine if the predicted future trajectory of the engine speed is within the allowable relative speed range at a single point during the pinion travel time range, at multiple points during the pinion travel time range, or during the entire pinion travel time range. If the ECU 20 determines that the predicted future trajectory of the of the engine speed is within the allowable relative speed range, the ECU 20 outputs signal SL1 to mesh the pinion 13 with the ring gear 23 and outputs signal SL2 to rotate the pinion 13. The ECU 20 may output signal SL1 and signal SL2 at a calculated time relative to the automatic stop of the engine 21 or a calculated crank angle relative to the automatic stop of the engine 21.

As discussed in detail below, Kawazu calculates a predicted future trajectory of the engine speed based on an assumption that the loss of kinetic energy (and loss of torque) of the engine 21 will be constant for each rotation of the crankshaft. In other words, Kawazu predicts that the loss of kinetic energy and loss of torque which will occur in future crankshaft rotations will be equal to the loss of kinetic energy and the loss of torque which occurred during a previous crankshaft rotation. This assumption, however, may not always be accurate.

FIG. 3(d) is a graph illustrating examples of engine speeds of four cylinder engines relative to the number of crank angle degrees (CAD) which have accumulated since an automatic stop (e.g., “fuel cut”) of each engine according to exemplary embodiments of the present invention.

For a four cylinder engine 21, each 180 CAD represents a full rotation of crankshaft 22 (i.e. a “stroke”). In the example illustrated in FIG. 3(d), the period from 720 CAD to 900 CAD is identified as stroke j-1, the period from 900 CAD to 1080 CAD is identified as stroke j, etc. Because the kinetic energy of an engine 21 is directly proportional to the angular velocity squared of the engine 21, the loss of kinetic energy of the engine 21 during one stroke can be calculated from the change of engine speed during that stroke. As shown in FIG. 3(d), experimental data shows that the loss of kinetic energy of an engine 21 during stroke j-1 may not be equal to the loss of kinetic energy during stroke j.

FIG. 3(e) is a graph illustrating example calculations of a ratio α of the loss of kinetic energy during a stroke of an engine 21 to the loss of kinetic energy during a previous stroke of the engine 21 according to exemplary embodiments of the present invention.

If the assumption used by Kawazu that the kinetic energy loss of an engine is constant from one stroke of an engine to the next were always correct, then the ratio α would always be equal to 1. As shown in FIG. 3(e), the ratio α does not always equal 1.

FIG. 3(f) is a graph illustrating the engine speed of an engine 21 relative to the number of crank angle degrees which have accumulated since an automatic stop of the engine 21 according to exemplary embodiments of the present invention.

Until the engine reaches Y crank angle degrees, the actual speed of the engine 21 (for example, measured by the ECU 20 based on input from crank angle sensor 25) is shown. Beginning at Y CAD, the ECU 20 calculates at least one predicted future trajectory of the engine speed. In the example illustrated in FIG. 3(f), three predicted future trajectories are calculated which vary based on the ratio α of the predicted kinetic energy loss during the stroke from Y CAD to Z CAD to the kinetic energy loss during the stroke from X CAD to Y CAD. FIG. 3(f) illustrates a predicted future trajectory where the ratio α is equal to 1, a predicted future trajectory where the ratio α is less than 1, and a predicted future trajectory where the ratio α is greater than 1.

After engine restart request, the ECU 20 may use any one or more of the three predicted future trajectories to determine if an expected engine speed will be within the allowable relative speed range to smoothly engage pinion 13 with the ring gear 23. Alternatively, the ECU 20 may use two or more predicted future trajectories to determine if a range of expected engine speeds will be within the allowable relative speed range to smoothly engage pinion 13 with the ring gear 23. In the example illustrated in FIG. 3(f), the ECU 20 calculates a range of expected engine speeds based on the predicted future trajectory where the ratio α is less than 1 and the predicted future trajectory where the ratio α is greater than 1.

FIG. 3(g) illustrates four examples of graphs illustrating the engine speed of an engine 21 relative to the number of crank angle degrees which have accumulated since an automatic stop of the engine 21 according to exemplary embodiments of the present invention.

In each example, the actual speed of the engine 21 (for example, measured by the ECU 20 based on input from crank angle sensor 25) is shown. Each example also illustrates the ECU 20 at Y CAD calculating a predicted future trajectory of the engine speed—assuming that the ratio α of kinetic energy loss is equal to 1—in order to determine a predicted engine speed at Z CAD. Both Y CAD and Z CAD are instances where a piston of the engine 21 is farthest from the crankshaft 22 (e.g., top dead center (TDC)).

Example 1 illustrates a case where the actual engine speed and the predicted engine speed relative to the angular velocity of the crankshaft 22 at Z CAD are both greater than 0. Accordingly, in example 1, the predicted future trajectory which assumes that the ratio α is equal to 1 is acceptable.

Example 2 illustrates a case where the predicted engine speed relative to the angular velocity of the crankshaft 22 at Z CAD is greater than 0. The actual engine speed, however, is less than 0. In other words, the engine 21 will be in reverse rotation at Z CAD. However, the ECU 20 in example 2 calculates a predicted future trajectory at Y CAD which erroneously predicts that the engine speed will be greater than 0 at Z CAD. In this instance, the erroneous prediction may cause the ECU 20 to output signal SL1 to mesh the pinion 13 with the ring gear 23 at Z CAD. Because the engine 21 at Z CAD is in reverse rotation, meshing the pinion 13 with the ring gear 23 at that time may cause increased noise and wear as described above. Accordingly, in example 2, the predicted future trajectory which assumes that the ratio α is equal to 1 is erroneous.

Example 3 illustrates a case where predicted engine speed relative to the angular velocity of the crankshaft 22 at Z CAD is less than 0. The actual engine speed, however, is greater than 0 at Z CAD. In other words, the ECU 20 incorrectly determines at Y CAD that the engine 21 will be in reverse rotation at Z CAD. In order to avoid meshing the pinion 13 with the ring gear 23 when the engine 21 is in reverse rotation, the ECU 20 may delay the output signal SL1. This delay reduces the responsiveness of engine 21 after an engine restart request. Accordingly, in example 2, the predicted future trajectory which assumes that the ratio α is equal to 1 is erroneous.

Example 4 illustrates a case where the actual engine speed and predicted engine speed at Z CAD relative to the angular velocity of the crankshaft 22 are both less than 0. In other words, the ECU 20 correctly determines at Y CAD that the engine 21 will be in reverse rotation at Z CAD. Accordingly, in example 4, the predicted future trajectory which assumes that the ratio α is equal to 1 is acceptable.

FIG. 3(h) is a graph illustrating the predicted future trajectory described above with reference to Example 2 of FIG. 3(g) in detail according to exemplary embodiments of the present invention.

Similar to FIG. 3(c), FIG. 3(h) illustrates an actual engine speed, a predicted future trajectory of the engine speed (“speed prediction”), a signal SL1 output by the ECU 20 to engage the pinion 13 with the ring gear 23, a signal SL2 output by the ECU 20 to rotate the pinion 13, a range of time which the pinion 13 may take to travel and mesh with the ring gear 23 (“pinion travel time range”) between signal SL1 and SL2, and an allowable relative speed range (between the “upper speed limit” and the “lower speed limit”) wherein the pinion 13 may smoothly engage with the ring gear 23.

After an engine restart request (“CoM”), the ECU 20 determines whether the predicted future trajectory of the engine speed is within the allowable relative speed range during the pinion travel time range. In the example illustrated in FIG. 3(h), the ECU 20 calculates the predicted future trajectory assuming the ratio α is equal to 1 and erroneously determines that the future trajectory of the engine speed will be within the allowable relative speed range during the pinion travel time range. Therefore, the ECU 20 outputs signal SL 1 to engage the pinion 13 with the ring gear 23. The actual engine speed, however, is outside allowable relative speed range. Specifically, the actual engine speed is negative relative to the angular velocity of the pinion when the pinion 13 is meshed with the ring gear 23 (a “negative engagement”). Accordingly, assuming the ratio α is equal to 1 may cause a negative engagement, which may cause increased noise and wear as described above.

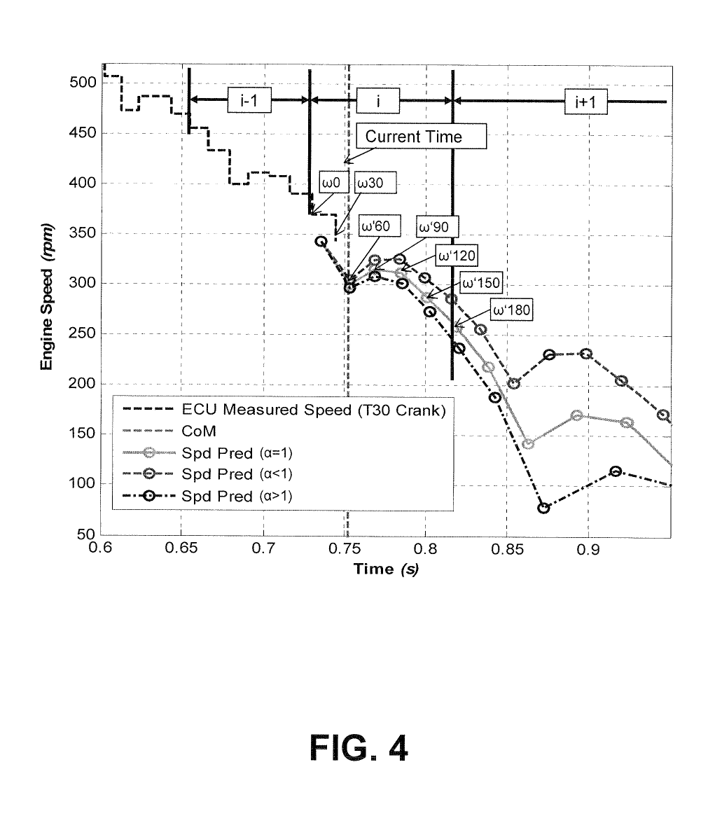

FIG. 4 is a timing chart illustrating the engine speed (angular velocity) of the engine 21 after the automatic stop of the engine 21 and a first predicted future trajectory of the engine speed (e.g., “Spd Pred α=1”), a second predicted future trajectory of the engine speed (e.g., “Spd Pred α>1”), and third predicted future trajectory of the engine speed (e.g., “Spd Pred α<1”), according to exemplary embodiments of the present invention.

After the automatic stop of the engine 21, the rotational speed of the engine 21 drops. As the rotational speed of the crankshaft 22 (and the engine 21) drops, the crank angle sensor 25 outputs a pulse (a “crank pulse”) to the ECU 20 every time the crankshaft 22 is rotated by 30 degrees (30 crank angle degrees or 30 CAD).

The ECU 20 computes (calculates) an angular velocity ω of the crankshaft 22 (engine 21) in accordance with the following equation (1) every time one crank pulse of the crank signal is currently inputted to the ECU 20 during the engine speed dropping:

$$ω [ rad \text{/} sec ] = \frac{20 \times 2 π}{360 \times tp} \qquad ( 1 )$$

where tp represents the pulse interval [sec] in the crank signal.

Because the engine 21 is a four-stroke, four-cylinder engine, the engine 21 has a cylinder on a power stroke every 180 degrees of the rotation of the crankshaft 22. For example, the crank angle of the crankshaft 22 is 0 degrees (0 crank angle degrees) relative to the reference position each time the piston in a cylinder is located at the TDC.

Note that “i” is a parameter indicative of a present period of 180 crank-angle degrees (CAD) of the rotation of the crankshaft 22. In other words, at current time CT, i−1 represents the previous 180 CAD period, i presents the current 180 CAD period and i+1 represents the next 180 CAD period. For example, ω[30,i] represents the angular velocity ω at 30 CAD after TDC during the current 180 CAD period.

Referring to FIG. 4, at a current time just before 60 CAD after TDC during the current 180 CAD period, the ECU 20 uses the angular velocity measurements previously stored (such as ω0 and ω30) to predict the angular velocities ω′60, ω′90, ω′120, etc. of a first predicted future trajectory (e.g., “Spd Pred α=1”), a second predicted future trajectory of the engine speed (e.g., “Spd Pred α>1”), and a third predicted future trajectory of the engine speed (e.g., “Spd Pred α<1”).

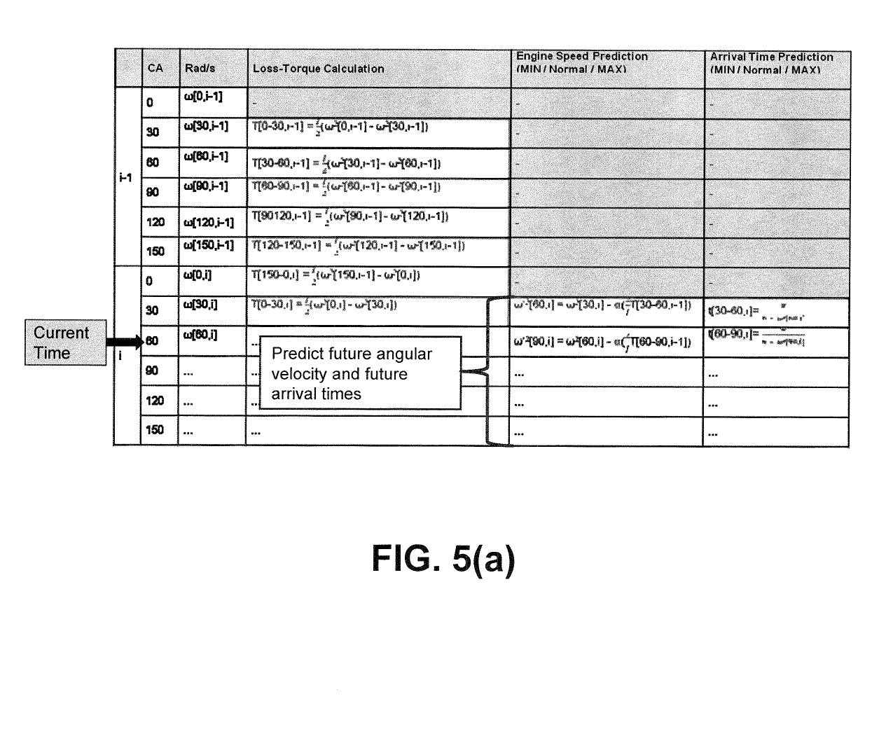

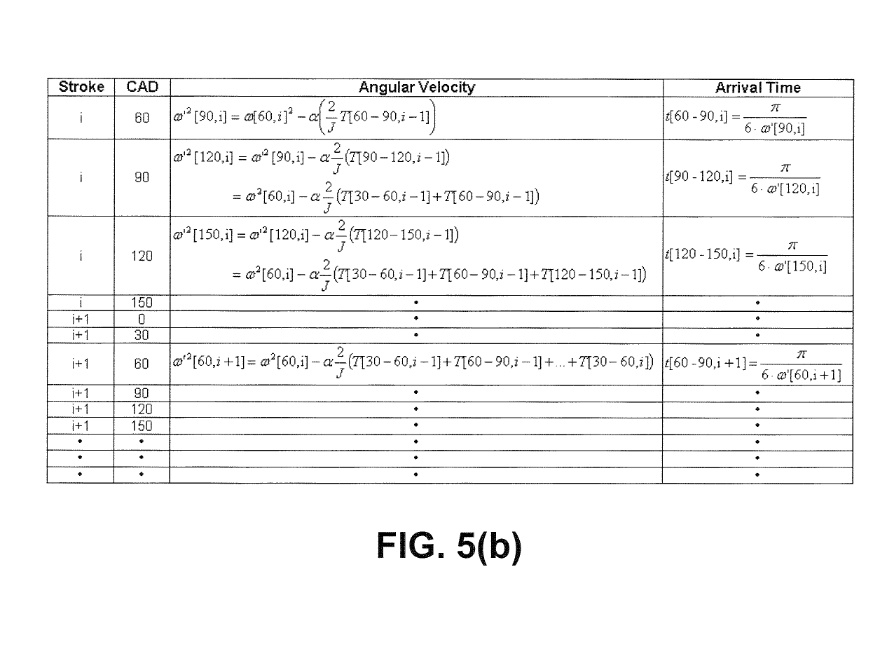

The calculation of the first, second, and/or third predicted future trajectories will now be described with reference to FIG. 5(a).

FIG. 5(a) is a table illustrating examples of methods to calculate predicted values of an angular velocity of the crankshaft of the internal combustion engine, and to predict values of arrival time of the crankshaft according to exemplary embodiments of the present invention.

As the engine speed drops, the ECU 20 calculates a value of the angular velocity co of the crankshaft 22 every rotation of the crankshaft 22 by 30 CAD in accordance with equation (1). The ECU 20 may store the computed values of the angular velocity ω in its register RE (a register of the CPU) and/or the storage medium 20a while updating them, for example, every 180 CAD period.

For example, if a crank pulse is currently inputted to the ECU 20 at current time (as shown in FIG. 5(a)) at 60 CAD past TDC within the present 180 CAD period of the rotation of the crankshaft 22, the ECU 20 may have calculated and stored:

a value ω[0, i−1] of the angular velocity ω at 0 CAD past the TDC of a previous cylinder (the previous TDC) in the firing order within the previous 180 CAD period of the rotation of the crankshaft 22;

a value ω[30, i−1] of the angular velocity ω at 30 CAD past the previous TDC within the previous 180 CAD period of the rotation of the crankshaft 22;

a value ω[60, i−1] of the angular velocity ω at 60 CAD past the previous TDC within the previous 180 CAD period of the rotation of the crankshaft 22;

a value ω[90, i−1] of the angular velocity ω at 90 CAD past the previous TDC within the previous 180 CAD period of the rotation of the crankshaft 22;

a value ω[120, i−1] of the angular velocity ω at 120 CAD past the previous TDC within the previous 180 CAD period of the rotation of the crankshaft 22;

a value ω[150, i−1] of the angular velocity ω at 150 CAD past the previous TDC within the previous 180 CAD period of the rotation of the crankshaft 22;

a value ω[0, i] of the angular velocity ω at 0 CAD past the TDC of the current cylinder (current TDC) within the current 180 CAD period of the rotation of the crankshaft 22;

a value ω[30, i] of the angular velocity ω at 30 CAD past the current TDC within the current 180 CAD period of the rotation of the crankshaft 22; and

a value [60, i] of the angular velocity ω at 60 CAD past the current TDC within the current 180 CAD period of the rotation of the crankshaft 22.

ECU 20 also computes a loss torque T during each 30 CAD rotation of the crankshaft 22 in accordance with the following equations (2) to (7).

T[0-30,i−1] represents the loss torque T from 0 CAD to 30 CAD past the previous TDC within the previous 180 CAD period (i−1) of the rotation of the crankshaft 22 and is calculated according to the following equation (2):

$$T [ 0 - 30 , i - 1 ] = \frac{J}{2} ( {ω}^{2} [ 30 , i - 1 ] - {ω}^{2} [ 0 , i - 1 ] ) \qquad ( 2 )$$

where J represents inertia (the moment of inertia) of the engine 21.

T[30-60, i−1] represents the loss torque T from 30 CAD to 60 CAD past the previous TDC within the previous 180 CAD period of the rotation of the crankshaft 22 and is calculated according to the following equation (3):

$$T [ 30 - 60 , i - 1 ] = \frac{J}{2} ( {ω}^{2} [ 60 , i - 1 ] - {ω}^{2} [ 30 , i - 1 ] ) \qquad ( 3 )$$

T[60-90, i−1] represents the loss torque T from 60 CAD to 90 CAD past the previous TUC within the previous 180 CAD period of the rotation of the crankshaft 22 and is calculated according to the following equation (4):

$$T [ 60 - 90 , i - 1 ] = \frac{J}{2} ( {ω}^{2} [ 90 , i - 1 ] - {ω}^{2} [ 60 , i - 1 ] ) \qquad ( 4 )$$

T[90-120, i−1] represents the loss torque T from 90 CAD to 120 CAD past the previous TDC within the previous 180 CAD period of the rotation of the crankshaft 22 and is calculated according to the following equation (5):

$$T [ 90 - 120 , i - 1 ] = \frac{J}{2} ( {ω}^{2} [ 120 , i - 1 ] - {ω}^{2} [ 90 , i - 1 ] ) \qquad ( 5 )$$

T[120-150, i−1] represents the loss torque T from 120 CAD to 150 CAD past the previous TDC within the previous 180 CAD period of the rotation of the crankshaft 22 and is calculated according to the following equation (6):

$$T [ 120 - 150 , i - 1 ] = \frac{J}{2} ( {ω}^{2} [ 150 , i - 1 ] - {ω}^{2} [ 120 , i - 1 ] ) \qquad ( 6 )$$

T[150-0, i] represents the loss torque T from 150 CAD past the previous TDC within the previous 180 CAD period of the rotation of the crankshaft 22 to the current TDC within the current 180 CAD period of the rotation of the crankshaft 22 and is calculated according to the following equation (7):

$$T [ 150 - 0 , i ] = \frac{J}{2} ( {ω}^{2} [ 0 , i ] - {ω}^{2} [ 150 , i - 1 ] ) . \qquad ( 7 )$$

T[0-30, i] represents the loss torque T from the current TDC within the current 180 CAD period of the rotation of the crankshaft 22 to 30 CAD past the current TDC within the current 180 CAD period of the rotation of the crankshaft 22 and is calculated according to the following equation (8):

$$T [ 0 - 30 , i ] = \frac{J}{2} ( {ω}^{2} [ 30 , i ] - {ω}^{2} [ 0 , i ] ) . \qquad ( 8 )$$

The ECU 20 stores the computed values of the loss torque T in its register RE (a register of the CPU) and/or the storage medium 20a.

In order to calculate the three future trajectories, the ECU 20 must have calculated and stored sufficient data regarding the loss torque T since the automatic stop condition of the engine 21 occurred and the rotational speed (and angular velocity) of the engine 21 and the crankshaft 22 began to decline. For example, the ECU 20 may use six loss torque T values that were calculated at 30 CAD intervals to calculate the first, second, and/or third predicted future trajectories of the engine speed as described below.

Specifically, at the current time illustrated in FIG. 5(a), a crank pulse is inputted to the ECU 20 at 60 CAD past TDC within the present 180 CAD period of the rotation of the crankshaft 22. The ECU 20 has previously calculated and stored the loss torque values T[30-60, i−1], T[60-90, i−1], T[190-120, i−1], T[120-150, i−1], T[150-0, i], and T[0-30, i] corresponding to the previous 180 CAD period of the rotation of the crankshaft 22 in its register RE (a register of the CPU) and/or the storage medium 20a. In response to the crank pulse at 60 CAD past TDC, the ECU 20 calculates and stores the angular velocity ω[60,i], calculates the loss torque T[30-60,i] and replaces the least recent loss torque value (in this example, T[30-60, i−1]).

All three predicted future trajectories follow the fundamental equation that kinetic energy during the next crank pulse will be equal the kinetic energy during the current crank pulse minus the loss torque T between crank pulses. For example, the kinetic energy of crankshaft 22 at 60 CAD (K[60,i]) will be equal to the kinetic energy of crankshaft 22 at 30 CAD (K[30,i]) minus the loss torque T[60-30,i]. Therefore, the kinetic energy can be calculated in accordance with the following equation (9):

K[60,i]=K[30,i]−T[30-60,i] (9)

The first predicted future trajectory assumes that the loss torque T during the next 30 CAD will be equal to the loss torque T of the previous equivalent 30 CAD. For example, the first predicted future trajectory assumes that T[30-60,i] will be equal to T[30-60,i−1]. Based on this assumption, the first predicted future trajectory is calculated by substituting the known value (the loss torque T[30-60,i−1]) for the unknown value (loss torque T[30-60,i]) to yield the following equation (10):

K[60,i]=K[30,i]−T[30-60,i−1] (10)

Kinetic energy K is be converted to angular velocity ω using the following equation (11):

K=½Jω² (11)

which yields the following equation (12):

$$\frac{1}{2} J {ω}^{′2} [ 90 , i ] = \frac{J}{2} {ω}^{2} [ 60 , i ] - T [ 60 - 90 , i - 1 ] \qquad ( 12 )$$

where ω′ is the predicted angular velocity.

Solving for ω′² yields the following equation (13):

$${ω}^{′2} [ 90 , i ] = {ω [ 60 , i ]}^{2} - \frac{2}{J} T [ 60 - 90 , i - 1 ] \qquad ( 13 )$$

As stated above, the first predicted future trajectory assumes that the loss torque T during the next 30 CAD will be equal to the loss torque T of the previous equivalent 30 CAD. That assumption, however, may not always prove correct. Accordingly, the ECU 20 also calculates a second predicted future trajectory which assumes the loss torque T during the next 30 CAD will be greater than the loss torque T of the previous equivalent 30 CAD and a third predicted future trajectory which assumes the loss torque T during the next 30 CAD will be less than the loss torque T of the previous equivalent 30 CAD.

α represents the ratio of the loss torque T during the next 30 CAD to the loss torque T of the previous equivalent 30 CAD as shown in the following equation (14):

$$α = \frac{T ( next30CAD )}{T ( previous30CAD )} \qquad ( 14 )$$

Including the loss torque ratio α in equation (13) yields in the following equation (15):

$${ω}^{′2} [ 90 , i ] = {ω [ 60 , i ]}^{2} - α ( \frac{2}{J} T [ 60 - 90 , i - 1 ] ) \qquad ( 15 )$$

where the loss torque ratio α may be equal to 1 when calculating the first future predicted trajectory, greater than 1 when calculating the second future predicted trajectory, and less than 1 when calculating the third future predicted trajectory.

The second future predicted trajectory may represent, for example, a minimum bound of a range of values of predicted rotational speeds of the crankshaft and the third future trajectory may represent, for example, a maximum bound of a range of values of predicted rotational speeds of the crankshaft.

The loss torque ratio α for the second and/or third future predicted trajectories may be determined, for example, based on an analysis of the energy loss of engine rundown data from test vehicles (“common calibration”). In another example, the loss torque ratio α for the second and/or third future predicted trajectories may updated in each vehicle (“adaptive calibration”) based on an analysis of the energy loss of engine rundown data from each vehicle (for example, at different temperatures, vehicle age, etc.).

Once each of the three predicted values ω′[90,i] have been calculated, the ECU 20 calculates a predicted value t[60-90,i] of arrival time at which the crankshaft 22 will arrive at 90 CAD relative to 60 CAD in accordance with the following equation (16):

$$t [ 60 - 90 , i ] = \frac{2 π \cdot 30}{360 \cdot {ω}^{′} [ 90 , i ]} = \frac{π}{6 \cdot {ω}^{′} [ 90 , i ]} \qquad ( 16 )$$

Each time the ECU 20 receive a crank pulse from crank angle sensor 25, the ECU 20 may calculate a first, second, and/or third predicted future trajectories for a predetermined number of crank angle degrees. For example, at 60 CAD past the current TDC within the current 180 CAD period of the rotation of the crankshaft 22, the ECU 20 may calculate a first, second, and/or third predicted future trajectories for 3×180 CAD (or three strokes of engine 21) according to the equations in FIG. 5(b).

FIG. 5(b) is a table illustrating examples of methods to calculate predicted values of an angular velocity of the crankshaft of the internal combustion engine, and to predict values of arrival time of the crankshaft according to exemplary embodiments of the present invention.

The ECU 20 calculates, based on the value T[90-120,i−1] of the loss torque T from 90 CAD to 120 CAD past the previous TDC within the previous 180 CAD period of the crankshaft rotation, a predicted value ω′[120, i] of the angular velocity ω at 120 CAD past the current TDC within the current 180 CAD period of the crankshaft rotation in accordance with the following equation (17):

$$\begin{matrix}{ω}^{′2} [ 120 , i ] = {ω}^{′2} [ 90 , i ] - α \frac{2}{J} ( T [ 90 - 120 , i - 1 ] ) \\ = {ω}^{2} [ 60 , i ] - \\ α \frac{2}{J} ( T [ 30 - 60 , i - 1 ] + T [ 60 - 90 , i - 1 ] )\end{matrix} \qquad ( 17 )$$

Also, based on the predicted values ω′[120,i] of the angular velocity ω, the ECU 20 calculates a predicted value t[90-120, i] of the arrival time at which the crankshaft 22 will arrive at 120 CAD relative to 90 CAD in accordance with the following equation (18):

$$t [ 90 - 120 , i ] = \frac{2 π \cdot 30}{360 \cdot {ω}^{′} [ 120 , i ]} = \frac{π}{6 \cdot {ω}^{′} [ 120 , i ]} \qquad ( 18 )$$

Similarly, the ECU 20 calculates, based on the value T[120-150,i−1] of the loss torque T from 120 CAD to 150 CAD past the previous TDC within the previous 180 CAD period of the crankshaft rotation, a predicted value ω′[150,i] of the angular velocity ω at 150 CAD past the current TDC within the current 180 CAD period of the crankshaft rotation in accordance with the following equation (19):

$$\begin{matrix}{ω}^{′2} [ 150 , i ] = {ω}^{′2} [ 120 , i ] - α \frac{2}{J} T [ 90 - 120 , i - 1 ] \\ = {ω}^{2} [ 30 , i ] - α \frac{2}{J} ( T [ 30 - 60 , i - 1 ] + \\ T [ 60 - 90 , i - 1 ] + T [ 90 - 120 , i - 1 ] )\end{matrix} \qquad ( 19 )$$

Based on the predicted value ω′[150,i] of the angular velocity w, the ECU 20 calculates a predicted value t[120-150,i] of the arrival time at which the crankshaft 22 will arrive at 150 CAD relative to 120 CAD in accordance with the following equation (20):

$$t [ 90 - 120 , i ] = \frac{2 π \cdot 30}{360 \cdot {ω}^{′} [ 120 , i ]} = \frac{π}{6 \cdot {ω}^{′} [ 120 , i ]} \qquad ( 20 )$$

That is, at the current time, the ECU 20 predicts what the angular velocity ω will be at intervals of 30 CAD of the rotation of the crankshaft 22, and what the arrival time will be at intervals of 30 CAD of the rotation of the crankshaft 22, thus predicting the future trajectory of the drop of the angular velocity of the crankshaft 22.

Specifically, each time a crank pulse is inputted to the ECU 20 from the crank angle sensor 25, the ECU 20 is programmed to carry out the predictions of the angular velocity ω and the arrival time to thereby update the previous predicted data of the future trajectory of the drop of the engine speed to currently obtained predicted data thereof within the time interval between the crank pulse and the next crank pulse that will be inputted to the ECU 20 from the crank angle sensor 25.

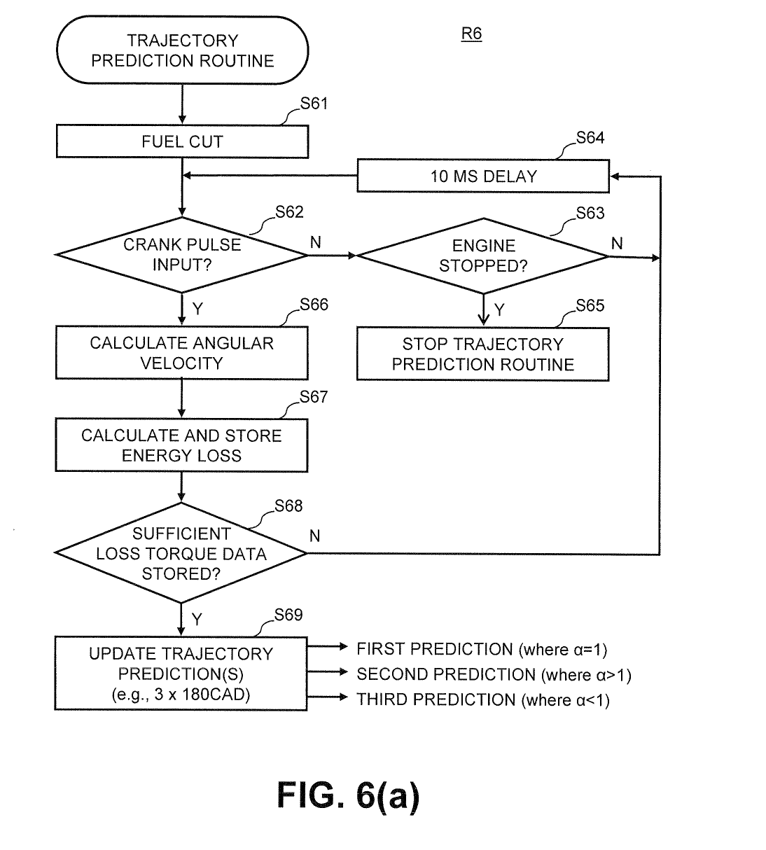

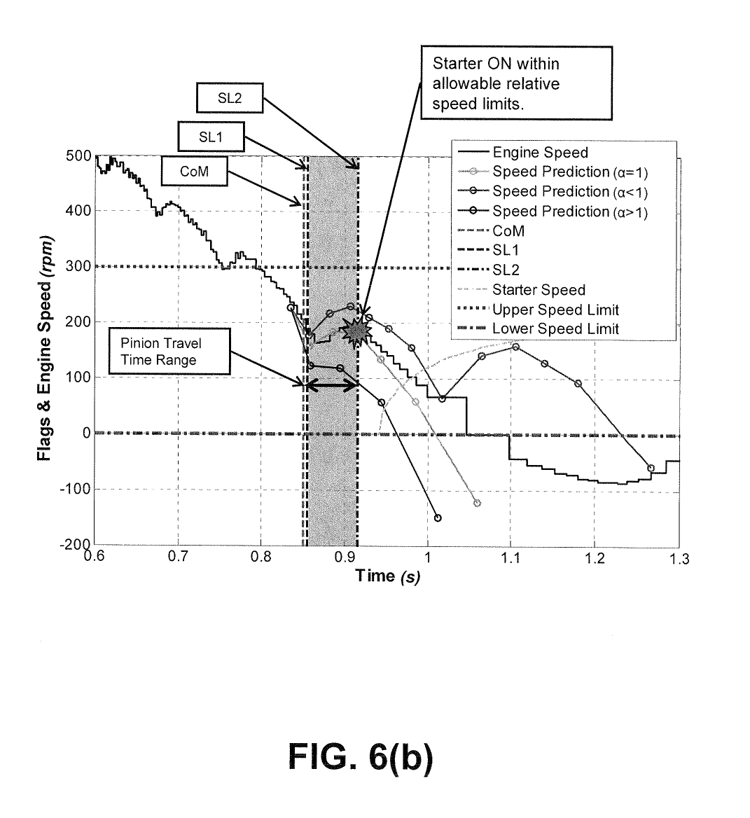

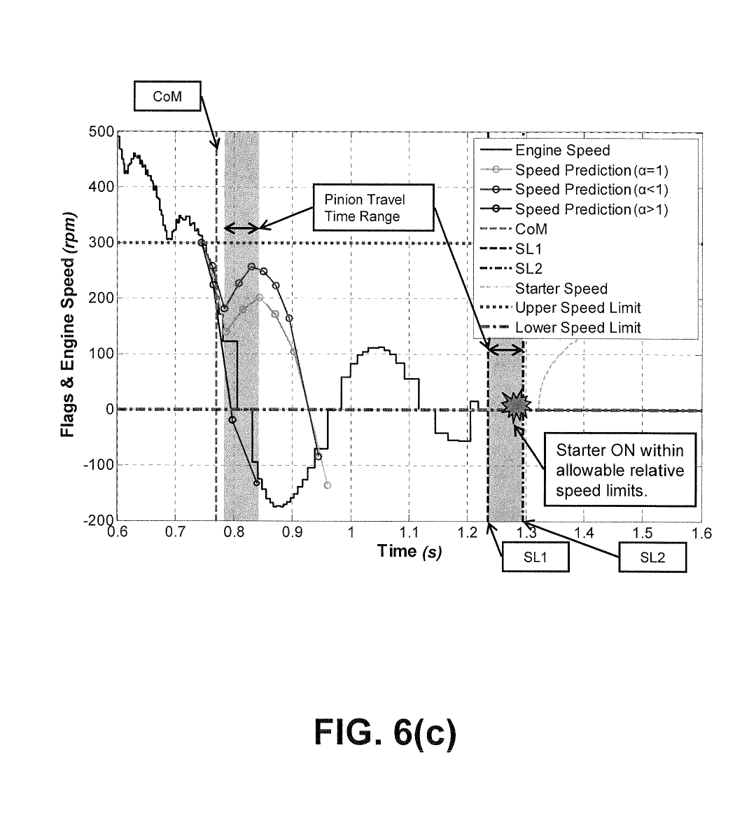

FIG. 6(a) is a flowchart illustrating trajectory prediction routine R6, executed by the ECU 20, to determine the first, second, and/or third predicted future trajectories of the engine speed, according to exemplary embodiments of the present invention.

Referring to FIG. 6(a), fuel is cut by the ECU 20 in operation S61 (for example, in response to an engine automatic stop request received from sensors 59). The ECU 20 determines whether a crank pulse is input in operation S62. If a crank pulse is not input (operation S62: No), the ECU 20 determines whether the engine has stopped in operation S63. If the ECU determines that the engine 21 has stopped (operation S63: Yes), the trajectory prediction routine is stopped in operation S65. If the ECU determines that the engine 21 has not stopped (operation S63: No), the ECU 20 performs a 10 millisecond delay in operation S64.

If the ECU 20 determines that a crank pulse is input (operation S62: Yes), the ECU 20 calculates the angular velocity ω of engine 21 based on equation (1) above in operation S66. The ECU 20 calculates and stores the loss of torque from the previous crank pulse to the current crank pulse input in operation S67. The ECU 20 determines whether sufficient loss torque data has been stored in order to make the trajectory predictions in operation S68. For example, the ECU 20 may store six loss torque measurements (over 180 CAD) before calculating the trajectory predictions. If insufficient loss torque data has been stored (operation S68: No), the ECU 20 performs a 10 millisecond delay in operation S64 and determines whether another crank pulse is input in operation S62. If sufficient loss torque data has been stored (operation S68: Yes), the ECU 20 calculates and stores a first predicted future trajectory of engine speed (e.g., where α=1) a second predicted future trajectory of engine speed (e.g., where α>1) and a third predicted future trajectory of engine speed (e.g., where α<1) in operation S69.

Provided sufficient loss torque data has been previously stored by ECU 20 (operation S68: Yes), the ECU 20 may calculate a first, second, and/or third predicted future trajectories for a predetermined number of crank angle degrees (operation S69). For example, the ECU 20 may calculate a first, second, and/or third predicted future trajectories for 3×180 CAD (or three strokes of engine 21) in response to each crank pulse.

FIG. 6(b) is a graph illustrating three predicted future trajectories which may be used to determine whether the predicted future trajectory of the engine speed is within the allowable relative speed range to mesh the pinion 13 with the ring gear 23 during the pinion travel time range according to exemplary embodiments of the present invention.

Similar to FIGS. 3(e) and 3(h), FIG. 6(b) illustrates an actual engine speed, a signal SL1 output by the ECU 20 to engage the pinion 13 with the ring gear 23, a signal SL2 output by the ECU 20 to rotate the pinion 13, a range of time which the pinion 13 may take to travel and mesh with the ring gear 23 (“pinion travel time range”) between signal SL1 and SL2, and an allowable relative speed range (between the “upper speed limit” and the “lower speed limit”) wherein the pinion 13 may smoothly engage with the ring gear 23.

The ECU 20 calculates three predicted future trajectories of the engine speed: one in which the ratio α is equal to 1 (“speed prediction (α=1)”), one in which the ratio α is less than 1 (“speed prediction (α<1)”), and one in which the ratio α is greater than 1 (“speed prediction (α>1)”). After an automatic stop of the engine 21, the engine speed drops. After the ECU 20 receives an engine restart request (“CoM”), the ECU 20 uses one or more of the three predicted future trajectories to determine whether the engine speed is within the allowable relative speed range to mesh the pinion 13 with the ring gear 23 during the pinion travel time range.

The ECU 20 may determine whether the engine speed is within the allowable relative speed range based on one of the three predicted future trajectories. Alternatively, the ECU 20 may use two of the three predicted future trajectories to predict a range of future trajectories and use the range of future trajectories to determine whether the engine speed is within the allowable relative speed range. Alternatively, the ECU 20 may determine whether the engine speed is within the allowable relative speed range based on all three predicted future trajectories.

In making the determination, the ECU 20 may test whether the one or more of the predicted future trajectories are within the allowable relative speed range at a single point during the pinion travel time range, at multiple points during the pinion travel time range, or during the entire pinion travel time range.

In the example illustrated in FIG. 6(b), the ECU 20 calculates the three predicted future trajectories and determines that the future trajectory of the engine speed will be within the allowable relative speed range during the pinion travel time range. Therefore, the ECU 20 outputs signal SL1 to engage the pinion 13 with the ring gear 23 and outputs signal SL2 to rotate the pinion 13. Because the actual engine speed is within the allowable relative speed range, the pinion 13 is smoothly engaged with the ring gear 23.

FIG. 6(c) is a graph illustrating three predicted future trajectories which may be used to determine whether the predicted future trajectory of the engine speed is within the allowable relative speed range to mesh the pinion 13 with the ring gear 23 during the pinion travel time range according to exemplary embodiments of the present invention.

Similar to FIGS. 3(c), 3(h), and 6(b), FIG. 6(c) illustrates an actual engine speed, a signal SL1 output by the ECU 20 to engage the pinion 13 with the ring gear 23, a signal SL2 output by the ECU 20 to rotate the pinion 13, a range of time which the pinion 13 may take to travel and mesh with the ring gear 23 (“pinion travel time range”) between signal SL1 and SL2, and an allowable relative speed range (between the “upper speed limit” and the “lower speed limit”) wherein the pinion 13 may smoothly engage with the ring gear 23.

The ECU 20 calculates three predicted future trajectories of the engine speed: one in which the ratio α is equal to 1 (“speed prediction (α=1)”), one in which the ratio α is less than 1 (“speed prediction (α<1)”), and one in which the ratio α is greater than 1 (“speed prediction (α>1)”). After an automatic stop of the engine 21, the engine speed drops. After the ECU 20 receives an engine restart request (“CoM”), the ECU 20 uses the three predicted future trajectories to determine whether the engine speed is within the allowable relative speed range to mesh the pinion 13 with the ring gear 23 during the pinion travel time range.

In making the determination, the ECU 20 may test whether the one or more of the predicted future trajectories are within the allowable relative speed range at a single point during the pinion travel time range, at multiple points during the pinion travel time range, or during the entire pinion travel time range.

In the example illustrated in FIG. 6(b), the ECU 20 calculates the three predicted future trajectories and determines that the future trajectory of the engine speed may not be within the allowable relative speed range during the first pinion travel time range after the engine restart request CoM. For example, the ECU 20 may determine that the engine speed may fall outside the allowable relative speed range because the predicted future trajectory in which the ratio α is greater than 1 falls outside the allowable relative speed range at one point during first pinion travel time range or at multiple points during first pinion travel time range. Alternatively, the ECU 20 may determine that the engine speed may fall outside the allowable relative speed range because the predicted future trajectory in which the ratio α is greater than 1 does not fall with the allowable relative speed range for the entire first pinion travel time range.

Because the ECU 20 determines that the engine speed may fall outside the allowable relative speed range, the ECU 20 does not output signal SL1 to mesh the pinion 13 with the ring gear 23. Instead, the ECU 20 delays outputting the signal SL1 until the engine speed (for example, as measured by the ECU 20 based on input from crank angle sensor 25) is within the allowable relative speed range to mesh the pinion 13 with the ring gear 23.

The first, second, and/or third future trajectories illustrated in FIG. 4 may alternatively be used to determine whether an error in the speed prediction trajectories exist.

The 3 future trajectories shown in FIG. 6(c) are an example of this error, when the sign (positive or negative) of the engine speed at the next TDC from the current time is not the same for the multiple future trajectories.

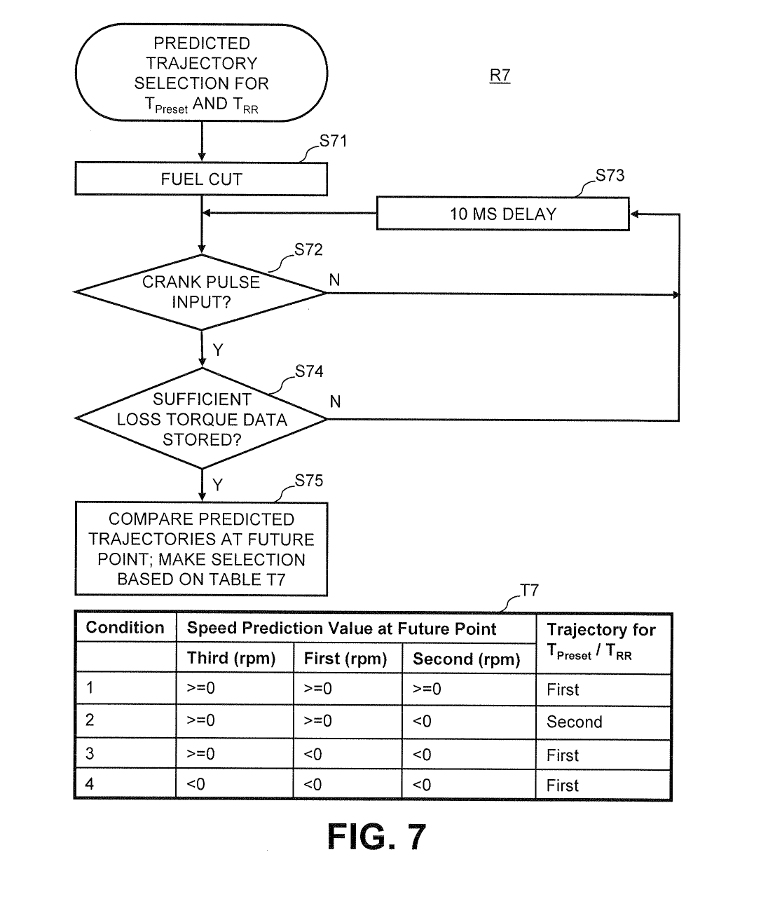

FIG. 7 is a flowchart illustrating trajectory selection routine R7, executed by the ECU 20, to determine whether an error in the speed prediction trajectories exist and if yes, then to select the future trajectory representing the minimum bound of a range of values of predicted rotational speeds of the crankshaft and determine the timing of the driving of the starter based on at least a portion of this future trajectory being within a predetermined range of rotational speed values.

Referring to FIG. 7, fuel is cut by the ECU 20 in operation S71 (for example, in response to an engine automatic stop request received from sensors 59). The ECU 20 determines whether a crank pulse is input in operation S72. If a crank pulse is not input, the ECU 20 performs a 10 millisecond delay in operation S73. If a crank pulse is input (operation S72: Yes), the ECU 20 determines whether sufficient loss torque data has been stored in order to make the trajectory selection in operation S74. For example, the ECU 20 may store six loss torque measurements (over 180 CAD) before selecting the trajectory prediction to determine the timing of the driving of the starter based on at least a portion of this future trajectory being within a predetermined range of rotational speed values. If insufficient loss torque data has been stored (operation S74: No), the ECU 20 performs a 10 millisecond delay in operation S73 and determines whether another crank pulse is input in operation S71. If sufficient loss torque data has been stored (operation S74: Yes), the ECU 20 calculates compares the first, second, and/or third predicted future trajectories at a predetermined future point in time (for example, the ECU 20 may compare the predicted future trajectories one full stroke in the future) to determine if an error in the speed prediction trajectories exists.

Table T7 lists four conditions based on whether or not the first, second and/or third predicted future trajectories are less than 0 RPMs at the predetermined future point in time used in operation S75 (in other words, whether each of the future trajectories predicts that the engine 21 will be have a negative or reverse rotation). In condition 1, because all three of the first, second, and third predicted future trajectories are greater than or equal to 0 RPMs, the first predicted future trajectory is used to determine the timing of the driving of the starter based on at least a portion of this future trajectory being within a predetermined range of rotational speed values. In condition 1, because only the second predicted future trajectory (e.g., the minimum bound of the future trajectory) is less than 0 RPMs, the second predicted future trajectory is used to determine the timing of the driving of the starter based on at least a portion of this future trajectory being within a predetermined range of rotational speed values. In condition 3, because the first and second predicted future trajectories are less than 0 RPMs and the third predicted future trajectory (e.g., the maximum bound of the future trajectory) is greater than or equal to 0, the first predicted future trajectory is used to determine the timing of the driving of the starter based on at least a portion of this future trajectory being within a predetermined range of rotational speed values. In condition 4, because all three of the first, second, and third predicted future trajectories are greater less than 0 RPMs, the first predicted future trajectory is used to determine the timing of the driving of the starter based on at least a portion of this future trajectory being within a predetermined range of rotational speed values.

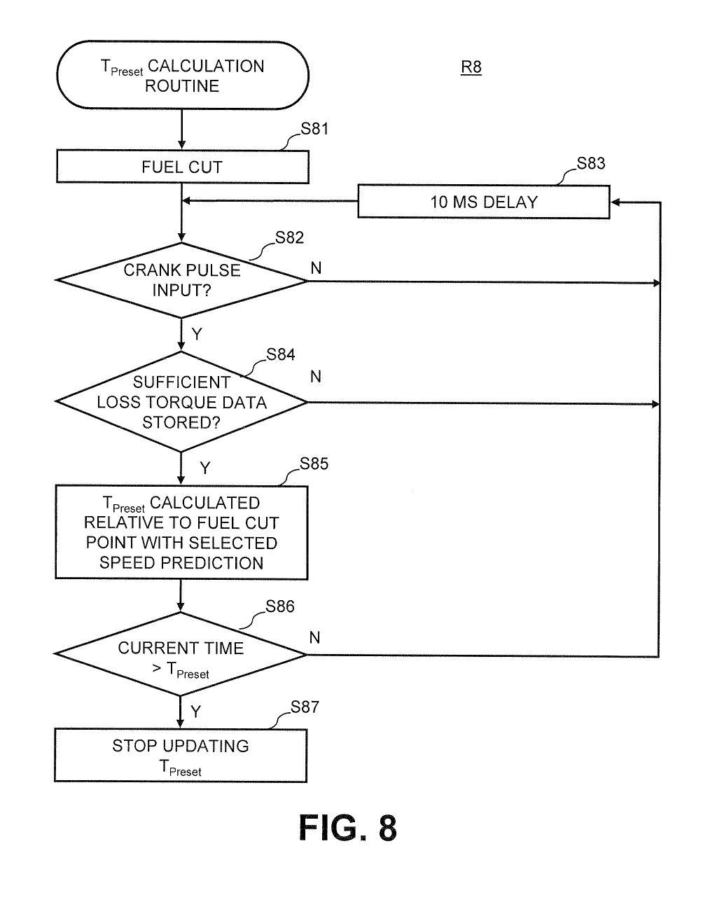

FIG. 8 is a flowchart illustrating T_{Preset} calculating routine R8, executed by the ECU 20, to calculate the time T_{Preset}, according to exemplary embodiments of the present invention.

Referring to FIG. 8, fuel is cut by the ECU 20 in operation S81 (for example, in response to an engine automatic stop request received from sensors 59). The ECU 20 determines whether a crank pulse is input in operation S82. If a crank pulse is not input (operation S82: No), the ECU 20 performs a 10 millisecond delay in operation S83. If a crank pulse is input (operation S82: Yes), the ECU 20 determines whether sufficient loss torque data has been stored in order to calculate the time T_{Preset} in operation S84. For example, the ECU 20 may store six loss torque measurements (over 180 CAD) before calculating the time T_{Preset}.

If insufficient loss torque data has been stored (operation S84: No), the ECU 20 performs a 10 millisecond delay in operation S83 and determines whether another crank pulse is input in operation S81. If sufficient loss torque data has been stored (operation S84: Yes), the ECU 20 calculates the time T_{Preset} using the predicted future trajectory selected in routine R7 of FIG. 7.

The time T_{Preset} may be calculated, for example, such that the pinion 13 is meshed with the ring gear 23 when the angular velocity of engine 21 is a predetermined value. For example, the pinion 13 may be meshed with the ring gear 23 an estimated 60 milliseconds after the signal SL1 is output from the ECU 20. Therefore, in order to mesh the pinion 13 with the ring gear 23 when the angular velocity of the engine 21 is 200 RPMs, T_{Preset} is calculated as 60 milliseconds prior to the time when the future trajectory selected in routine R7 of FIG. 7 predicts the angular velocity of engine 21 will be 200 RPMs. T_{Preset} is calculated relative to the time the fuel is cut in operation S81.

The ECU determines if the current time is after T_{Preset} in operation S86. If the ECU 20 determines that the time T_{Preset} has yet to arrive (operation S86: No), the ECU 20 performs a 10 millisecond delay in operation S83 and determines whether another crank pulse is input in operation S82. If the ECU 20 determines that the time T_{Preset} has passed (operation S86: Yes), the ECU 20 stops updating the time T_{Preset} in operation S87.

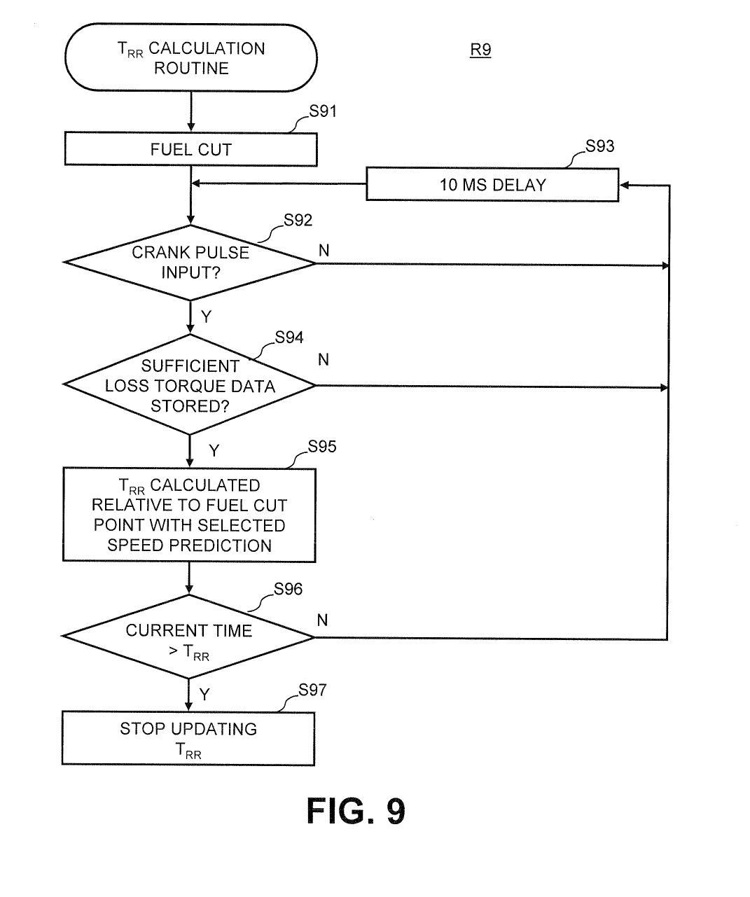

FIG. 9 is a flowchart illustrating T_{RR} calculating routine R9, executed by the ECU 20, to calculate the time T_{RR}, according to exemplary embodiments of the present invention.

Referring to FIG. 9, fuel is cut by the ECU 20 in operation S91 (for example, in response to an engine automatic stop request received from sensors 59). The ECU 20 determines whether a crank pulse is input in operation S92. If a crank pulse is not input, the ECU 20 performs a 10 millisecond delay in operation S93. If a crank pulse is input (operation S92: Yes), the ECU 20 determines whether sufficient loss torque data has been stored in order to calculate the time T_{RR} in operation S94. For example, the ECU 20 may store six loss torque measurements (over 180 CAD) before calculating the time T_{RR}.

If insufficient loss torque data has been stored (operation S94: No), the ECU 20 performs a 10 millisecond delay in operation S93 and determines whether another crank pulse is input in operation S91. If sufficient loss torque data has been stored (operation S94: Yes), the ECU 20 calculates the time T_{RR} using the predicted future trajectory selected in routine R7 of FIG. 7.

The time T_{RR} may be calculated, for example, such that the pinion 13 is meshed with the ring gear 23 when the angular velocity of engine 21 is a predetermined value. For example, the pinion 13 may be meshed with the ring gear 23 an estimated 60 milliseconds after signal SL1 is output from the ECU 20. Therefore, in order to mesh the pinion 13 with the ring gear 23 when the angular velocity of the engine 21 is 0, T_{RR} is calculated as 60 milliseconds prior to the time when the future trajectory selected in routine R7 of FIG. 7 predicts the angular velocity of engine 21 will be 0. T_{RR} is calculated relative to the time of the fuel cut in operation S91.

The ECU determines if the current time is after T_{RR} in operation S96. If the ECU 20 determines that the time T_{RR} has yet to arrive (operation S96: No), the ECU 20 performs a 10 millisecond delay in operation S93 and determines whether another crank pulse is input in operation S92. If the ECU 20 determines that the time T_{RR} has passed, (operation S96: No), the ECU 20 stops updating the time T_{RR} in operation S97.

Routines R6 to R9 as described above may be stored in the storage medium 20a of the ECU 20 of the engine control system 1 and executed by its computer processor.

In each of the above-described embodiments, the crank-angle measurement resolution may be set to any desired angle and is not limited to 30 CAD as described above.

While illustrative embodiments of the invention have been described herein, the present invention is not limited to the various embodiments described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be constructed as non-exclusive.

What is claimed is:

1. A system for driving a starter including a pinion so that the starter rotates a ring gear coupled to a crankshaft of an internal combustion engine to crank the internal combustion engine during a drop of a rotational speed of the crankshaft by automatic-stop control of the internal combustion engine, the system comprising:
a processing system, comprising a computer processor, configured to:
predict multiple future trajectories of the drop of the rotational speed of the crankshaft based on information associated with the drop of the rotational speed of the crankshaft; and
determine a timing of the driving of the starter based on these multiple future trajectories.

2. The system as in claim 1, wherein the multiple future trajectories represent any two or more of a minimum bound of a range of values of predicted rotational speeds of the crankshaft, a maximum bound of the range of values of predicted rotational speeds of the crankshaft, and a predicted rotational speed of the crankshaft having values within the range of values of the predicted rotational speeds of the crankshaft.

3. The system as in claim 1, wherein the timing of the driving of the starter is determined based on at least a portion the future trajectories being within a predetermined range of rotational speed values.

4. The system as in claim 1, wherein the multiple future trajectories are:
a first future trajectory of the drop of the rotational speed of the crankshaft based on information associated with the drop of the rotational speed of the crankshaft;
a second future trajectory of the drop of the rotational speed of the crankshaft based on information associated with the drop of the rotational speed of the crankshaft; and
a third future trajectory of the drop of the rotational speed of the crankshaft based on information associated with the drop of the rotational speed of the crankshaft; and
the processing system is configured to determine a timing of the driving of the starter based on the first future trajectory, the second future trajectory, and the third future trajectory.

5. The system as in claim 4, wherein the first future trajectory represents predicted rotational speeds of the crankshaft having values which are greater than those of the second trajectory but less than those of the third future trajectory.

6. The system as in claim 4, wherein the second future trajectory and the third future trajectory respectively represent minimum and maximum bounds of a range of values of predicted rotational speeds of the crankshaft, the first future trajectory representing predicted rotational speeds of the crankshaft having values within the range.

7. The system as in claim 6, wherein the range is determined based on an analysis of energy loss of engine rundown data from test combustion engines.

8. The system as in claim 6, wherein the range is determined based on an analysis of energy loss of engine rundown data from the internal combustion engine.

9. The system as in claim 4, wherein the first future trajectory is predicted based on a ratio of an energy loss on a next stroke of the engine to an energy loss on a previous stroke of the engine being equal to 1, the second future trajectory is predicted based on a ratio of an energy loss on a next stroke of the engine to an energy loss on a previous stroke of the engine not being equal to 1, and the third future trajectory is predicted based on a ratio of an energy loss on a next stroke of the engine to an energy loss on a previous stroke of the engine not being equal to 1.

10. The system as in claim 9, wherein the second future trajectory is predicted based on the ratio of the energy loss on the next stroke of the engine to the energy loss on the previous stroke of the engine being greater than 1, and the third future trajectory is predicted based on the ratio of an energy loss on the next stroke of the engine to the energy loss on a previous stroke of the engine being less than 1.

11. The system as in claim 4, wherein the timing of the driving of the starter is determined based on at least a portion of each of the first, second and third future trajectories being within a predetermined range of rotational speed values.

12. The system as in claim 11, wherein the timing of the driving of the starter is determined based on at least a portion of each of the first, second and third future trajectories being within the predetermined range of rotational speed values during a pinion travel time range.

13. The system according to claim 4, wherein the determination of the timing of the driving of the starter includes determination of a first timing to drive a pinion actuator to shift the pinion to the ring gear and a second timing to drive a motor to rotate the pinion.

14. The system according to claim 4, wherein the processing system is further configured to calculate a time to preset the pinion to the ring gear based on the first, second and third trajectories.

15. The system according to claim 4, wherein the processing system is further configured to select one of the first, second and third trajectories and calculate a time to preset the pinion to the ring gear based on the selected trajectory.

16. The system as in claim 2, wherein the processing system is further configured to compare any 2 or more of the multiple future trajectories and determine whether an error in speed prediction exists.

17. The system according to claim 16, wherein the processing system is further configured to select the future trajectory representing the minimum bound of a range of values of predicted rotational speeds of the crankshaft if an error in speed prediction exists.

18. The system according to claim 17, wherein the processing system is further configured to determine the timing of the driving of the starter is based on at least a portion the future trajectory being within a predetermined range of rotational speed values.

19. The system according to claim 4, wherein the processing system is further configured to select one of the first, second and third trajectories and calculate a time when the engine will enter a reverse rotation based on the selected trajectory.

20. The system as in claim 1, wherein the timing of the driving of the starter is determined based on at least a portion the future trajectories being within a predetermined range of rotational speed values.

21. The system as in claim 20, wherein the timing of the driving of the starter is determined based on at least a portion of the future trajectories being within the predetermined range of rotational speed values during a pinion travel time range.

22. The system as in claim 21, wherein the timing of the driving of the starter is determined based on at least a portion of the future trajectories being within the predetermined range of rotational speed values at two or more points during the pinion travel time range.

23. The system as in claim 21, wherein the timing of the driving of the starter is determined based on at least a portion of the future trajectories being within the predetermined range of rotational speed values during the entire pinion travel time range.

24. A system for driving a starter including a pinion so that the starter rotates a ring gear coupled to a crankshaft of an internal combustion engine to crank the internal combustion engine during a drop of a rotational speed of the crankshaft by automatic-stop control of the internal combustion engine, the system comprising:
a processing system, comprising a computer processor, configured to:
predict a future trajectory of the drop of the rotational speed of the crankshaft based on information associated with the drop of the rotational speed of the crankshaft, wherein the future trajectory is predicted based on a predicted energy loss on a next stroke of the engine which is not equal to a previous energy loss on a previous stroke of the engine; and
determine a timing of the driving of the starter based on the future trajectory.

25. The system as in claim 24, wherein the timing of the driving of the starter is determined based on at least a portion the future trajectory being within a predetermined range of rotational speed values.

26. The system as in claim 25, wherein the timing of the driving of the starter is determined based on at least a portion of the future trajectory being within the predetermined range of rotational speed values during a pinion travel time range.

27. The system as in claim 26, wherein the timing of the driving of the starter is determined based on at least a portion of the future trajectory being within the predetermined range of rotational speed values at two or more points during the pinion travel time range.

28. The system as in claim 26, wherein the timing of the driving of the starter is determined based on at least a portion of the future trajectory being within the predetermined range of rotational speed values during the entire pinion travel time range.

29. A system for driving a starter including a pinion so that the starter rotates a ring gear coupled to a crankshaft of an internal combustion engine to crank the internal combustion engine during a drop of a rotational speed of the crankshaft by automatic-stop control of the internal combustion engine, the system comprising:
a processing system, comprising a computer processor, configured to:
predict a future trajectory of the drop of the rotational speed of the crankshaft based on information associated with the drop of the rotational speed of the crankshaft; and
determine a timing of the driving of the starter based on at least a portion the future trajectory being within a predetermined range of rotational speed values at two or more points during a pinion travel time range.

30. The system as in claim 29, wherein the timing of the driving of the starter is determined based on at least a portion of the future trajectory being within the predetermined range of rotational speed values during the entire pinion travel time range.
